(19) United States
(12) Patent Application Publication
(10) Pub. No.: US 2018/0236777 A1
(43) Pub. Date: Aug. 23, 2018

(54) MANUFACTURING METHOD OF LIGHT TRANSMISSION FILTER, MANUFACTURING APPARATUS OF LIGHT TRANSMISSION FILTER, TRANSFER MATERIAL FOR LIGHT TRANSMISSION FILTER, AND LIGHT TRANSMISSION FILTER

(71) Applicant: CANON FINETECH NISCA INC., Misato-shi (JP)

(72) Inventors: Hiromitsu Hirabayashi, Yokohama-shi (JP); Yusuke Sumikawa, Kashiwa-shi (JP); Takahiro Tsutsui, Matsudo-shi (JP)

(21) Appl. No.: 15/892,787

(22) Filed: Feb. 9, 2018

(30) Foreign Application Priority Data
Feb. 17, 2017 (JP) 2017-027972

(51) Int. Cl. B41J 2/21; B05D 1/28; B05D 3/02; B41M 3/00; G02B 5/22

(52) U.S. Cl. CPC B41J 2/21; B05D 1/28; G02B 5/223; B41M 3/003; B41M 3/008; B05D 3/0254

(57) ABSTRACT

In a manufacturing method of a light transmission filter of the invention, an ink receiving layer formed by mutually laminating a pigment permeation layer which is capable of allowing a pigment particle and a solvent contained in a pigment ink for a light transmission filter to permeate, and a solvent absorption layer which is capable of inhibiting permeation of the pigment particle and of absorbing the solvent is prepared, and the pigment ink is applied from the pigment permeation layer side of the ink receiving layer. Then, at least a part of the solvent absorption layer containing a solvent component of the pigment ink is removed from the ink receiving layer.

### BACKGROUND OF THE INVENTION

### Field of the Invention

The present invention relates to a light transmission filter and a manufacturing method thereof which can be used for various applications such as a display device or an imaging element.

### Description of the Related Art

There is a method using an applying technology, a dyeing method, or the like of a printing plate as a manufacturing method of a color filter, but a device or a producing step is complicated. In response, in Japanese Patent Laid-Open No. S59-75205 (1984), a method is disclosed in which a color filter is prepared by ink jet printing with a simple device or step. However, in a technology disclosed in Japanese Patent Laid-Open No. S59-75205 (1984), it is necessary to form a water-repellent or hydrophilic pattern in advance on a board as a pre-treatment in order to suppress the bleeding of an ink.

In addition, in Japanese Patent Laid-Open No. S63-235901 (1988), a technology is disclosed in which a bank frame is formed in advance on a board by using a dielectric body such as silicon oxide, and then, dyeing is performed by ink jet printing, and thus, the bleeding of an ink is suppressed, as a manufacturing method of a color filter using ink jet printing.

Further, in Japanese Patent Laid-Open No. H10-104607 (1998), an ink receiving layer containing a photosensitive resin composition is disposed on a board on which a black matrix (a light shielding layer) is formed in advance, and then, a non-colored portion corresponding to the black matrix is formed on the ink receiving layer by pattern exposure.

In addition, in Japanese Patent Laid-Open No. H11-167014 (1999), a technology is disclosed in which a first ink receiving layer, and a second ink receiving layer containing a photosensitive resin composition are disposed on a board on which a black matrix (a light shielding layer) is formed in advance, and a non-colored portion is formed on the second ink receiving layer by pattern exposure, and then, coloring is performed by ink jet printing. According to such a technology, the coloring is performed by the ink jet printing from the second ink receiving layer side on which the non-colored portion is formed into the shape of a matrix, and thus, it is possible to suppress the mixing of colors. Further, in such a technology, the first ink receiving layer in contact with a flat board is sufficiently dyed with an ink, and then, a heating treatment is performed while performing a drying treatment with respect to the ink, and thus, the ink receiving layer is cured. For this reason, the ink is absorbed, and the first ink receiving layer convexly expands, and thus, it is possible to suppress unevenness in a pigment concentration distribution. However, in order to control the bleeding of the ink between the adjacent pixels, a complicated device using a mask for pattern exposure is required, and a complicated step of positioning the mask is also required. In addition, in order to ensure absorption capacity of the ink, the first ink receiving layer also has an air gap structure which is sufficiently larger than a pigment particle, as with the second ink receiving layer. For this reason, light scattering occurs due to the air gap structure, and thus, there is a concern that a transparency of a color filter considerably decreases.

In Japanese Patent Laid-Open No. 2006-201435, a method is also proposed in which a convex portion of a negative pattern is compressed against an ink receiving layer disposed on a support member, the pattern is peeled off and removed into the shape of a grid, the pattern is transferred onto a transparent board, and the ink receiving layer in the shape of a pattern is formed, and then, coloring is performed by ink jet printing. According to this, the ink receiving layer on which the pattern is removed into the shape of a grid is subjected to the coloring, and thus, it is possible to prevent the colors from being mixed between the adjacent pixels. However, it is necessary to separately prepare a step of removing the pattern or a black matrix, and a step of obtaining a positioning accuracy with respect to the ink receiving layer in the shape of a pattern is also required.

As described above, in the manufacturing method of a color filter of the related art, a pre-treatment of preparing a bank or a non-colored portion is required in order to prevent the colors from being mixed due to the bleeding of the ink between the adjacent pixels, and thus, a device configuration or a manufacturing step becomes complicated.

### SUMMARY OF THE INVENTION

An object of the invention is to provide a method and a device in which a light transmission filter having excellent optical properties can be manufactured by simple means and steps.

In order to attain the object described above, the invention provides a manufacturing method of a light transmission filter, including at least one of: an ink applying step of applying a pigment ink for a light transmission filter to an ink receiving layer formed by mutually laminating a pigment permeation layer which is capable of allowing a pigment particle and a solvent contained in the pigment ink to permeate, and a solvent absorption layer having an air gap structure which is capable of inhibiting permeation of the pigment particle and of absorbing the solvent, from the pigment permeation layer side; a solvent absorption layer removing step of removing at least a part of the solvent absorption layer containing a solvent component of the pigment ink from the ink receiving layer.

In addition, the invention provides a manufacturing apparatus of a light transmission filter, including at least one of: an ink applying unit applying a pigment ink for a light transmission filter to an ink receiving layer formed by mutually laminating a pigment permeation layer which is capable of allowing a pigment particle and a solvent contained in the pigment ink to permeate, and a solvent absorption layer having an air gap structure which is capable of inhibiting permeation of the pigment particle and of absorbing the solvent, from the pigment permeation layer side; a solvent absorption layer removing unit removing at least a part of the solvent absorption layer containing a solvent component of the pigment ink from the ink receiving layer.

In addition, the invention provides a transfer material for a light transmission filter, including: a solvent absorption layer which is capable of inhibiting permeation of a pigment particle contained in a pigment ink for a light transmission filter and of allowing a solvent to permeate in the pigment ink; and a pigment permeation layer which is laminated on the solvent absorption layer, and is capable of allowing the pigment particle and the solvent to permeate.

In addition, the invention provides a light transmission filter, including: a pigment permeation layer which is capable of allowing a pigment particle and a solvent contained in a pigment ink for a light transmission filter to permeate; and the pigment particle which is retained in an air gap formed in the pigment permeation layer.

According to the invention, it is possible to manufacture a light transmission filter having excellent optical properties by simple means and steps.

Further features of the present invention will become apparent from the following description of exemplary embodiments with reference to the attached drawings.

### BRIEF DESCRIPTION OF THE DRAWINGS

FIGS. 1A to 1E are longitudinal sectional views illustrating a configuration of a transfer material used in an embodiment;

FIGS. 2A to 2E are explanatory diagrams illustrating a manufacturing step of a light transmission filter of the embodiment;

FIGS. 3A and 3B are explanatory diagrams illustrating an ink absorption mechanism of the transfer material of the embodiment and a transfer material of the related art;

FIGS. 4A and 4B are sectional views illustrating an example of an enhanced adhesive layer of the transfer material and a state after a pressurizing and heating treatment;

FIGS. 5A and 5B are sectional views illustrating another example of the enhanced adhesive layer of the transfer material and a state after the pressurizing and heating treatment;

FIG. 6 is an explanatory longitudinal side sectional view illustrating a state of a pigment permeation layer and a solvent absorption layer before and after a pressurizing and heating treatment using a pressurizing and heating roll;

FIGS. 7A and 7B are explanatory diagrams illustrating a removing step of the solvent absorption layer;

FIGS. 8A and 8B are explanatory diagrams illustrating an absorption process of a pigment ink for a light transmission filter with respect to the pigment permeation layer and the solvent absorption layer;

FIG. 9 is a explanatory diagram illustrating a manufacturing apparatus of a light transmission filter; and

FIG. 10 is an explanatory diagram illustrating an absorption state of a color pigment ink for a light transmission filter after a black matrix is formed.

### DESCRIPTION OF THE EMBODIMENTS

An embodiment of the invention will be described on the basis of the drawings.

### (Basic Configuration of Light Transmission Filter and Manufacturing Method Thereof)

In this embodiment, a manufacturing method of a light transmission filter basically includes the following steps.

(i) A transfer material for a light transmission filter is prepared in which two or more air gap absorption type ink receiving layers having different air gap diameters are mutually laminated to be peelable.

(ii) A pigment ink for a light transmission filter containing a pigment having predetermined optical properties is applied to the prepared transfer material for a light transmission filter, and only a pigment particle is retained in one ink receiving layer, and only a solvent of the pigment ink for a light transmission filter is absorbed in the other ink receiving layer.

(iii) The ink receiving layer absorbing the solvent is peeled off from the ink receiving layer retaining the pigment particle.

By performing the steps described above, it is possible to manufacture the light transmission filter having predetermined optical properties. Hereinafter, a manufacturing step of the light transmission filter will be described in detail by adopting a manufacturing method of a color filter which can be used in various applications such as a color display device or a color imaging element, as an example.

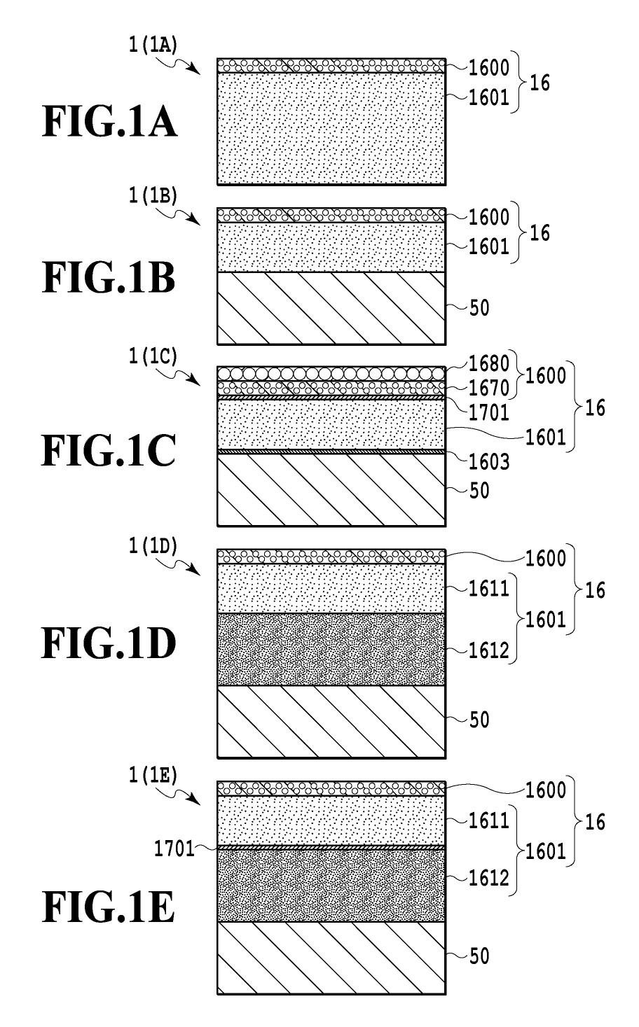

As illustrated in FIG. 1A, a transfer material for a light transmission filter 1A (hereinafter, referred to as a transfer material for a color filter, or simply referred to as a transfer material) described above is configured of an ink receiving layer 16 including a pigment permeation layer 1600 absorbing the pigment particle of the pigment ink for a light transmission filter, and a solvent absorption layer 1601 absorbing the solvent of the pigment ink for a light transmission filter applied to a print surface of the pigment permeation layer 1600 (in the drawing, an upper surface side). The pigment permeation layer 1600 has an air gap structure having an air gap diameter which is sufficiently larger than the pigment particle, and is formed of a material which can be formed into a molten film by pressurizing and heating, into a thin film. The solvent absorption layer 1601 has an air gap structure having an air gap diameter which is sufficiently smaller than the pigment particle, is configured of a material which can be peeled off from the pigment permeation layer 1600, and is configured of a thick film compared to the pigment permeation layer 1600. A transfer material 1 is formed by laminating the pigment permeation layer 1600 on a front surface of the solvent absorption layer 1601 (in the drawing, the upper surface). A specific example of a laminating method will be described later in detail.

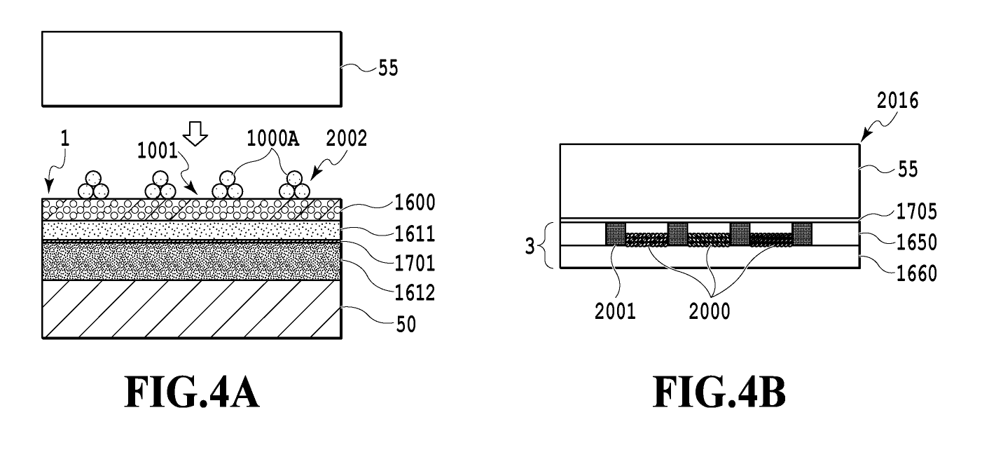

In addition, as illustrated in FIG. 1B, the transfer material can also be configured by laminating the ink receiving layer 16 formed of the solvent absorption layer 1601, the pigment permeation layer 1600, and the like on a substrate 50. Here, as with a transfer material 1B, adopting a configuration including the substrate 50 is effective from the viewpoint of improving the productivity of the transfer material 1, of improving conveying performance of the transfer material at the time of applying an ink to the ink receiving layer 16, or of improving handling properties at the time of adhesively transferring the transfer material to a predetermined image support 55 (refer to FIG. 4A) or peelability of the solvent absorption layer. Furthermore, the substrate 50 laminated on the transfer material 1 can be removed along with the solvent absorption layer 1601 by being subjected to the peeling treatment, the dissolution washing treatment, or the like to be described later, after the ink applying step to be described later with respect to the transfer material 1 and an adhesively transferring step with respect to the image support 55. Accordingly, it is possible to eliminate an air gap of the solvent absorption layer.

In addition, other configurations can also be adopted as the transfer material 1. For example, the transfer material can also be configured as illustrated in FIGS. 1C to 1E.

In addition, the transfer material can also be configured of a plurality of pigment permeation layers having different air gap diameters. An example thereof is illustrated in FIG. 1C. In a transfer material 1C of FIG. 1C, the pigment permeation layer 1600 has a configuration in which a first pigment permeation layer 1670 positioned on the solvent absorption layer 1601 side, and a second pigment permeation layer 1680 positioned on a front surface side which is an application surface of the ink (in the drawing, the upper surface side) are laminated. The first pigment permeation layer 1670 has an air gap structure which is sufficiently larger than the pigment particle of the pigment ink for a light transmission filter, and the second pigment permeation layer 1680 has an air gap structure which is larger than that of the first pigment permeation layer 1670. In addition, in the transfer material 1C of FIG. 1C, a release layer 1701 is disposed between the first pigment permeation layer 1670 and the solvent absorption layer 1601, and the solvent absorption layer 1601 is easily removed from the first pigment permeation layer 1670. Further, an adhesion layer 1603 for increasing adhesion between the solvent absorption layer 1601 and the substrate 50 is disposed between the solvent absorption layer 1601 and the substrate 50. For this reason, the solvent absorption layer 1601 and the substrate 50 can be easily removed from the first pigment permeation layer 1670.

Further, the transfer material can also be configured of a plurality of solvent absorption layers having different air gap diameters. A transfer material 1D illustrated in FIG. 1D includes a first solvent absorption layer 1611 and a second solvent absorption layer 1612 which are mutually laminated and are formed between the pigment permeation layer 1600 and the substrate 50, as an example. The first solvent absorption layer 1611 positioned on a rear surface side of the pigment permeation layer 1600 (in the drawing, a lower surface side) has an average air gap diameter which is sufficiently smaller than the pigment particle of the pigment ink for a light transmission filter, and the second solvent absorption layer 1612 positioned on an upper surface side of the substrate 50 has an average air gap diameter which is smaller than that of the first solvent absorption layer 1611, and is formed to have a thickness which is larger than that of the first solvent absorption layer 1611. In the solvent absorption layer 1601 having a two-layer structure solvent, the solvent which is absorbed through the pigment permeation layer 1600, is absorbed and retained in the second solvent absorption layer 1612 through the first solvent absorption layer 1611.

In addition, in the transfer material including the plurality of solvent absorption layers, the release layer can also be formed between the mutually adjacent solvent absorption layers. For example, as with a transfer material 1E illustrated in FIG. 1E, the release layer 1701 can also be formed between two solvent absorption layers (the first solvent absorption layer 1611 and the second solvent absorption layer 1612). Accordingly, in the solvent absorption layer 1601, a part of the solvent absorption layer in which the solvent is absorbed and retained, that is, the second solvent absorption layer 1612 can be peeled off from the first solvent absorption layer 1611 in which the solvent is not retained.

Furthermore, in the following description, the transfer materials 1A to 1E may be collectively referred to as the transfer material 1. In addition, the plurality of pigment permeation layers (the first pigment permeation layer 1670 and the second pigment permeation layer 1680) may be collectively referred to as the pigment permeation layer 1600, and the plurality of solvent absorption layers (the first solvent absorption layers 1611 and 1612) may be collectively referred to as the solvent absorption layer 1601.

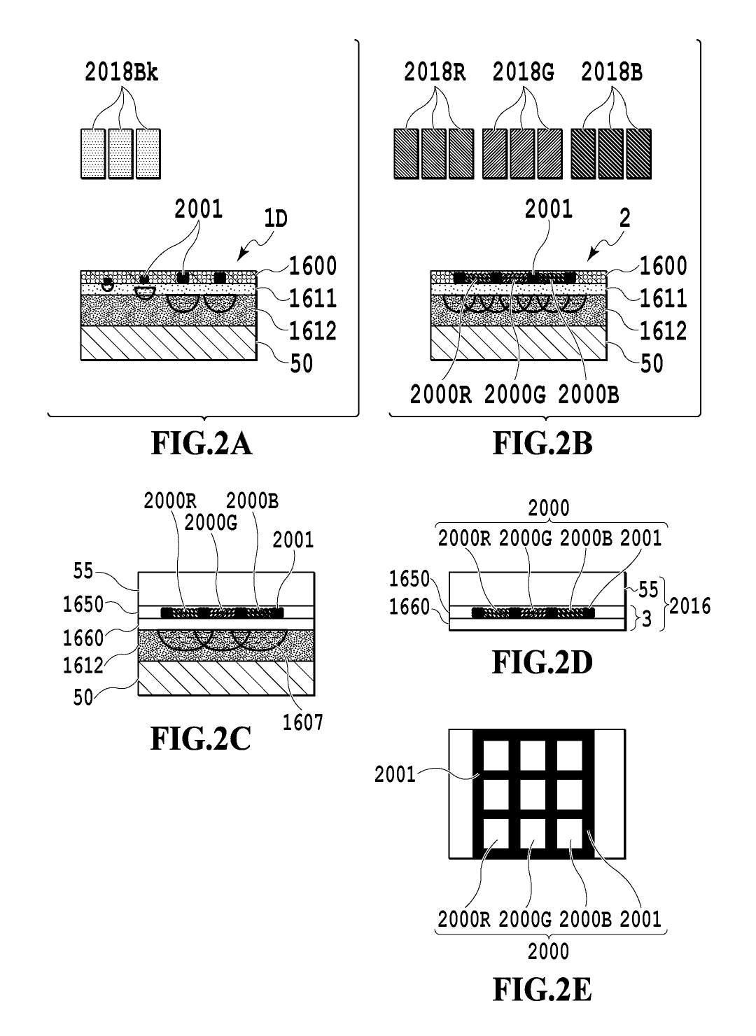

Next, a manufacturing method of a color filter using the transfer material for a color filter of this embodiment will be described with reference to FIGS. 2A to 2E. Furthermore, an example of manufacturing a color filter 2016 by using the transfer material 1D illustrated in FIG. 1D is described in the manufacturing method illustrated in FIGS. 2A to 2E. First, a black pigment ink for a light transmission filter is applied to the transfer material 1D by a print head 2018Bk disposed in an ink jet printing apparatus 2018, and thus, a black matrix 2001 is formed (FIG. 2A). The black matrix is formed into the shape of a grid as illustrated in FIG. 2E. Next, a color pigment ink for a light transmission filter, that is, pigment inks for a light transmission filter of three primary colors of red (R), green (G), and blue (B) are applied to a plurality of regions defined by the black matrix 2001 (FIG. 2B). The color pigment ink for a light transmission filter is applied by respectively ejecting the color inks of red (R), green (G), and blue (B) from print heads 2018R, 2018G, and 2018B disposed in the ink jet printing apparatus 2018. As described above, a transfer material 2 is prepared in which color filter images 2000R, 2000G, and 2000B, and an image 2000 formed of a color pattern such as the black matrix 2001 are formed on the transfer material 1D.

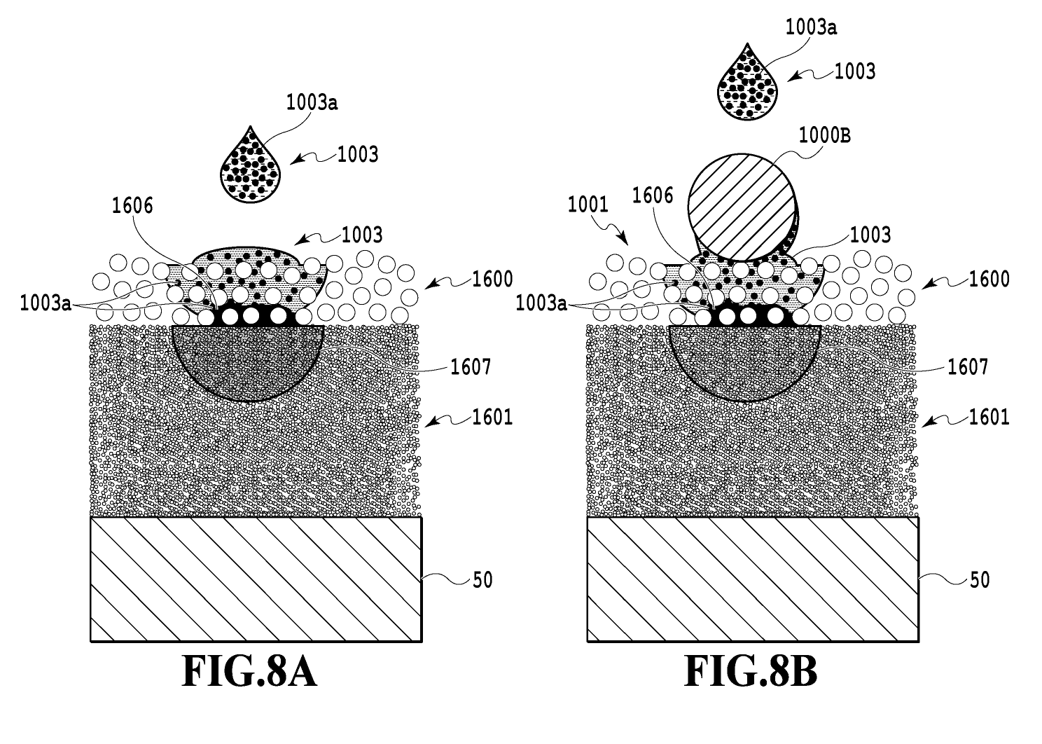

In a case where a pigment ink for a light transmission filter 1003 is ejected onto a front surface of the pigment permeation layer 1600, which is a thin film, by the ink jet printing apparatus, as illustrated in FIG. 8A, the pigment ink for a light transmission filter permeates in the pigment permeation layer 1600. The average pore size of the air gap formed in the pigment permeation layer 1600 is sufficiently larger than the diameter of the pigment particle, which is the color material of the pigment ink for a light transmission filter 1003, and thus, the pigment ink for a light transmission filter ejected onto the front surface of the pigment permeation layer 1600 smoothly permeates in the pigment permeation layer 1600 due to a capillary phenomenon. On the other hand, the average pore size of the air gap formed in the solvent absorption layer 1601, which is a thick film, is formed to be sufficiently smaller than the pigment particle diameter, and thus, the pigment ink for a light transmission filter which permeates in the pigment permeation layer 1600 and reaches an interface between the pigment permeation layer 1600 and the solvent absorption layer 1601, is subjected to solid-liquid separation on the interface. That is, the pigment ink for a light transmission filter is separated into the pigment particle and the solvent component on the interface, and only the solvent component is absorbed in the solvent absorption layer, and a thin film-like pigment film 1606 is densely formed on a bottom interface with respect to the pigment permeation layer 1600. In an air gap type ink absorption layer, when an ink is absorbed due to a capillary phenomenon, a capillary force of the ink increases as the pore size of the air gap decreases. For this reason, most of a solvent component 1607 is rapidly absorbed in the solvent absorption layer 1601 without remaining on the pigment permeation layer 1600. In the example illustrated in FIGS. 2A to 2E, the solvent absorption layer 1601 is configured of the first solvent absorption layer 1611, and the second solvent absorption layer 1612 having an average air gap diameter which is smaller than that of the first solvent absorption layer 1611, and thus, most of the solvent component permeating in the first solvent absorption layer 1611 is absorbed in the second solvent absorption layer 1612. Each of the plurality of regions to which the color ink is applied, is defined by the black matrix, and the bleeding of the ink is suppressed due to ink absorption properties of the transfer material 1D, and thus, a mixed color is not generated between different color inks applied to the adjacent regions.

As described above, the transfer material 2 is formed, and then, as illustrated in FIG. 2C, a transparent image support 55 such as a glass board, and the transfer material 2 overlap each other, and the transparent image support 55 and the transfer material 2 are subjected to a pressurizing and heating treatment by a pressurizing and heating device. Accordingly, the pigment permeation layer 1600 is formed into a molten film, becomes a transparent pigment retention film 1650, and is adhesively transferred to the image support 55. In addition, the first solvent absorption layer 1611 configuring the multi-layered solvent absorption layer 1601 is also configured of a material which can be formed into a molten film by being subjected to the pressurizing and heating treatment. For this reason, the solvent absorption layer 1601 is also formed into a molten film along with the first solvent absorption layer 1611 by performing the heating and pressurizing treatment, and becomes a transparent protective film 1660, and thus, both of the layers are integrated. Here, the second solvent absorption layer 1612 maintains a state of absorbing the solvent component without being formed into a molten film. After that, the second solvent absorption layer 1612 containing the solvent of the pigment ink for a light transmission filter is removed by using a peeling and removing device. Accordingly, as illustrated in FIG. 2D, it is possible to suppress a reduction in the haze by the solvent absorption layer absorbing the solvent component, and to prepare the color filter 3 having excellent light transmission absorption properties on the image support 55 with high definition.

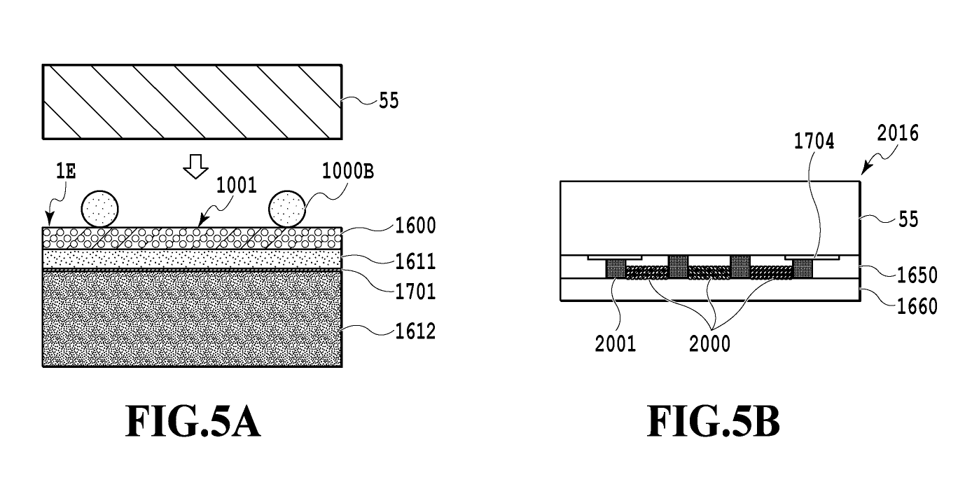

In addition, in the transfer material 1, in order to further improve adhesion when the pigment permeation layer is formed into a molten film and is adhesively transferred to the image support 55, as illustrated in FIG. 5A, an adhesive agent 1000B can be patchily provided, and as illustrated in FIG. 4A, an enhanced adhesive layer 2002 can be provided in the shape of a sea-and-island. Further, as illustrated in FIG. 1C, the second pigment permeation layer 1680 having excellent adhesion with respect to the image support 55 may be provided.

In addition, as illustrated in FIGS. 1C to 1E, in a case where each of the pigment permeation layer and the solvent absorption layer are sequentially formed by being divided into a plurality of layers, it is necessary that the air gap diameter sequentially decreases towards a non-print surface side (the substrate side). That is, layers of the number of each of the pigment permeation layers 1600 and solvent absorption layers 1601 may configure the air gap absorption type ink receiving layer, and the capillary force of the ink may sequentially increase towards the non-print surface side.

In addition, it is possible to dispose the adhesion layer for preventing interlayer peel-off not only in the transfer material 1C illustrated in FIG. 1C but also other transfer materials according to the invention. For example, it is also possible to dispose the adhesion layer 1603 improving the adhesion on the interface with respect to any one of the substrate 50, the solvent absorption layer 1601, the plurality of solvent absorption layers (1611 and 1612), and the pigment permeation layer 1600 or the plurality of pigment permeation layers (1670 and 1680), as necessary, in consideration of a material, a film production method, and the like of each of the layers. According to this, it is possible to prevent inadvertent interlayer peel-off at the time of performing ink jet printing. Here, in a case where capillary permeation of the pigment ink for a light transmission filter on the interlayer is necessary, it is necessary that the adhesion layer 1603 is configured of a material in consideration of hydrophilicity such that the movement of the pigment ink for a light transmission filter is not hindered by the capillary phenomenon, into the shape of a very thin film.

Further, a transfer material 1A illustrated in FIG. 1A is also adhesively transferred to the image support 55 by the pressurizing and heating treatment, and then, the release layer 1701 of a very thin film may be disposed between the solvent absorption layer 1601 and the pigment permeation layer 1600 such that the solvent absorption layer 1601 is easily removed from the pigment retention film 1650 which is formed into a molten film.

### (Rapid Solvent Absorptivity)

Here, absorption and permeation of the pigment ink for a light transmission filter in the transfer material 1 will be described in more detail. In the transfer material 1, the air gap structure of the of the pigment permeation layer 1600 has an air gap diameter which is sufficiently larger than the pigment particle. For this reason, the pigment permeation layer 1600 has a small capillary force, but flow path resistance is small, and thus, as illustrated in FIG. 8A, the pigment ink for a light transmission filter 1003 printed on the front surface of the pigment permeation layer 1600 smoothly permeates and is smoothly absorbed in the pigment permeation layer 1600 along with the pigment particle.

On the other hand, the air gap structure of the solvent absorption layer 1601 is configured of a pore which is sufficiently smaller than a pigment particle 1003a, and thus, a capillary force generated herein is significantly larger than a capillary force generated in the air gap structure of the pigment permeation layer 1600. In addition, the solvent absorption layer 1601 has an air gap which is smaller than the pigment particle 1003a, and thus, the flow path resistance is large. For this reason, the pigment particle 1003a is retained on the interface between the pigment permeation layer 1600 and the solvent absorption layer 1601, and only the solvent component 1607 is absorbed in the solvent absorption layer 1601. In a case where a part of the pigment ink for a light transmission filter 1003 which is absorbed and permeates from the front surface of the solvent absorption layer 1601 reaches the interface with respect to the solvent absorption layer 1601, the solvent component 1607 of the pigment ink for a light transmission filter 1003 is started to be absorbed due to an significantly large capillary force of the solvent absorption layer 1601.

In a case where the solvent component 1607 is started to be absorbed in the solvent absorption layer 1601, the pigment permeation layer 1600 has small flow resistance, and thus, the pigment ink for a light transmission filter 1003 remaining in the pigment permeation layer 1600 is also started to sequentially permeate due to the viscosity and the surface tension thereof without being torn. That is, in a case where a part of the pigment ink for a light transmission filter reaches the solvent absorption layer 1601, the solvent absorption layer 1601, which is a thick film, rapidly absorbs the solvent component 1607, and thus, a subsequent pigment ink for a light transmission filter 1003 existing in the pigment permeation layer 1600 also sequentially permeates towards the interface with respect to the solvent absorption layer 1601.

Thus, in the transfer material 1 of this example, the solvent absorption layer 1601 having a small air gap, which is a thick film, rapidly absorbs the solvent component, and thus, the pigment ink for a light transmission filter sequentially permeates in the pigment permeation layer 1600 having a large air gap. In addition, the solvent absorption layer 1601 is formed to have a thickness at which all solvent components of the pigment ink for a light transmission filter ejected to the pigment permeation layer 1600 can be sufficiently absorbed. For this reason, approximately all of the solvent components 1607 of the pigment ink for a light transmission filter 1003 ejected to the pigment permeation layer 1600 are rapidly absorbed in the solvent absorption layer 1601, and the solvent component 1607 rarely remains in the pigment permeation layer 1600. Accordingly, in a pressurizing and overheating treatment with respect to the transfer material and the image support 55, it is possible to allow the transfer material 1 to exhibit excellent adhesion, and to obtain an excellent adhesive state between the image support 55 and the transfer material 1.

In addition, the ink ejected to the pigment permeation layer 1600 is absorbed in the solvent absorption layer 1601 for a short period of time, and thus, it is possible to rapidly start the pressurizing and heating treatment without performing a special drying step or drying time after the ink jet printing. That is, the solvent absorption layer 1601 having a high ink absorption speed and large ink absorption capacity, which is a thick film, absorbs and retains approximately all of the solvent components 1607 while maintaining the air gap structure, and thus, even in a case where a pigment image rapidly adheres to the image support 55 after being printed, a decrease in the adhesion due to reverse flow or seeping out of the solvent component 1607 hardly occurs.

In addition, in a case where an ink droplet of the pigment ink for a light transmission filter 1003 is extremely small, there is a concern that the pigment ink for a light transmission filter does not reach the interface between the pigment permeation layer 1600 and the solvent absorption layer 1601 in a portion where one dot (a simple dot) is printed, but the pigment ink for a light transmission filter is held in the pigment permeation layer 1600 in an isolated state. However, even in a case where the ink droplet of the pigment ink for a light transmission filter 1003 is extremely small, the pigment ink for a light transmission filter 1003, which reaches first, is extruded by the absorption and permeation of the subsequent pigment ink for a light transmission filter 1003 in a print portion having a high concentration onto which a plurality of dots are landed, and thus, the ink droplet of the pigment ink for a light transmission filter, which reaches first, reaches the interface with respect to the solvent absorption layer 1601. As a result thereof, the subsequent pigment ink for a light transmission filter 1003 is rapidly absorbed and rapidly permeates towards the solvent absorption layer 1601. In the transfer material for a color filter of this embodiment, there are many cases where high concentration printing is performed with respect to one surface, and thus, the amount of pigment ink for a light transmission filter to be printed on the pigment permeation layer 1600 increases. For this reason, a tip end of the pigment ink for a light transmission filter applied to the pigment permeation layer 1600 easily reaches the interface with respect to the solvent absorption layer 1601, and approximately all of the solvent components 1607 are rapidly absorbed in the solvent absorption layer 1601. In addition, the pigment permeation layer, which is an ink jet print surface, is an air gap absorption type ink receiving layer, and thus, is capable of smoothly absorbing the pigment ink for a light transmission filter compared to a swelling absorption type ink receiving layer. Therefore, the pigment permeation layer has excellent fixability, and thus, less ink is held in a front surface, and ink spattering or flying due to ink droplet to be subsequently landed decreases, and thus, a print accuracy is high. In addition, ink holding time in the pigment permeation layer decreases, and thus, bleeding in a planar direction of the pigment ink for a light transmission filter is also suppressed, and thus, high definition printing can be performed. As described above, it is desirable that the pigment ink for a light transmission filter 1003 printed from the front surface of the pigment permeation layer 1600 rapidly reaches the interface with respect to the solvent absorption layer 1601, and in order for this, it is desirable that the pigment permeation layer 1600 is configured as a thin film to be smaller than the ink droplet of the pigment ink for a light transmission filter.

### (Formation of Thin and Dense Pigment Film and Mass of Solvent Absorption)

As described above, in the ink jet transfer material for a color filter of this embodiment, the air gap structure of the solvent absorption layer 1601 is configured of a pore which is sufficiently smaller than the pigment particle 1003a. For this reason, as illustrated in FIG. 8A, the pigment particle 1003a is subjected to solid-liquid separation on the interface with respect to the solvent absorption layer 1601, and only the solvent component 1607 of the pigment ink for a light transmission filter 1003 is rapidly absorbed in the solvent absorption layer 1601. That is, the solvent absorption layer 1601 having a significantly large capillary force rapidly and sequentially absorbs the solvent component 1607 of the pigment ink for a light transmission filter 1003 on an interface between the bottom of the pigment permeation layer 1600 and the solvent absorption layer 1601. For this reason, a thin and dense pigment image is formed while the pigment particle 1003a is compressed, according to the flow of the pigment ink for a light transmission filter 1003 when the pigment particle 1003a is subjected to the solid-liquid separation on the bottom of the pigment permeation layer 1600.

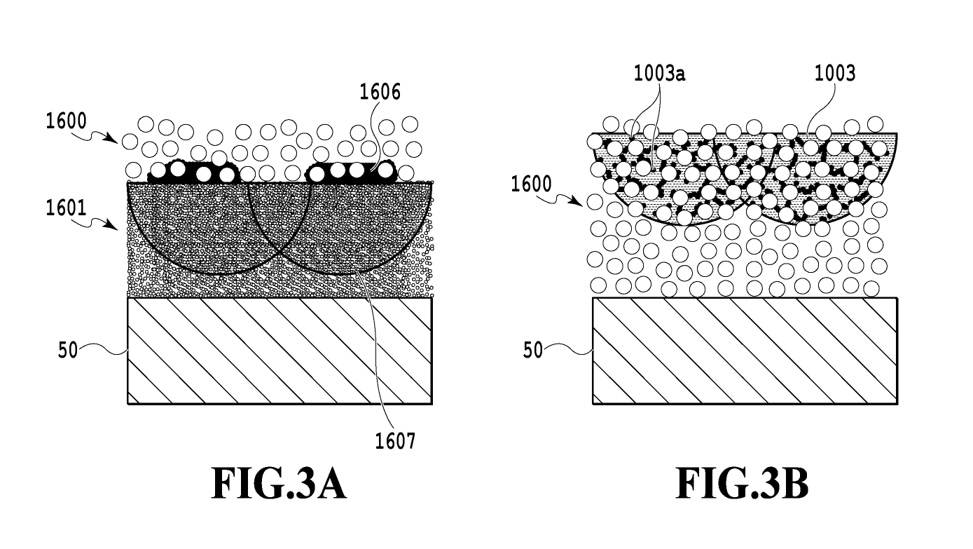

The pigment image in which the pigment particle 1003a, which is a color material, is densely stacked into the shape of a thin film, has excellent light absorption properties and excellent coloring capability. In this example, the solvent component 1607 mainly configuring the pigment ink for a light transmission filter 1003 is formed to have a thickness which is sufficient to be capable of being entirely absorbed in the solvent absorption layer 1601, and thus, large absorption capacity is ensured. For this reason, the pigment permeation layer 1600 may have air gap capacity only for being capable of storing all of the pigment particles 1003a subjected to the solid-liquid separation, and can be configured to be a thin layer. As illustrated in FIG. 3A, the pigment ink for a light transmission filter 1003 landed on the front surface of the pigment permeation layer 1600 is diffused even in the planar direction at the time of being absorbed and permeating in the air gap in the pigment permeation layer 1600. However, a permeation and diffusion width thereof is approximately same as a film thickness of the pigment permeation layer 1600, which is a thin film. Accordingly, in the transfer material 1 of this embodiment, the permeation and diffusion width in the pigment permeation layer 1600, which is a thin film, is small, and a deterioration in resolution is also small, compared to the related art in which the pigment particle permeates and is diffused over the entire ink receiving layer, which is a thick film.

On the other hand, as with the transfer material of the related art illustrated in FIG. 3B, in a case where the pigment permeation layer 1600 in which the pigment particle is capable of permeating, is configured to be a thick film, and the ink receiving layer is configured such that all of the printed pigment inks for a light transmission filter 1003 are absorbed only in the pigment permeation layer 1600, the pigment ink for a light transmission filter equally permeates and is equally diffused even in the planar direction and in a film thickness direction. That is, the pigment particles are absorbed and fixed in a state of being widely dispersed. Thus, in a case where the pigment ink for a light transmission filter permeates and is diffused in the planar direction, a deterioration in print resolution easily occurs. In addition, in a case where the pigment particles 1003a, which are a color material, are widely and sparsely dispersed in the film thickness direction, light absorption properties of transmission light at the time of being used as a color filter easily deteriorate. Further, the air gap structure which is sufficiently larger than the pigment particle, is close to a wavelength region of visible light, and the transmission light easily scatters due to the air gap structure, and thus, a haze reduction easily occurs.

In response, as illustrated in FIG. 2A, in the ink jet transfer material 1 for a color filter of this embodiment, the pigment permeation layer 1600 is configured to be a thin film, and thus, it is possible to suppress the permeation and diffusion of the pigment particle in the planar direction. For this reason, it is possible to perform printing with high definition and a small deterioration in the resolution. Further, the solvent absorption layer 1601 having a large capillary force, which is a thick film, rapidly absorbs the solvent component of the pigment ink for a light transmission filter, and thus, the pigment film 1606 in which the pigment particle, which is a color material, is thinly and densely compressed, is formed on a bottom interface of the pigment permeation layer 1600. Accordingly, it is possible to form a color filter which is excellent for the light absorption properties of the transmission light.

### (Overprinting of Low Concentration Ink for Forming Pigment Retention Film Having High Concentration)

In the pigment ink for a light transmission filter used in the ink jet printing, refill properties are necessary in which an ink droplet can be stably formed in an ejection port of a print head, and the ejection port can be swiftly filled with the ink. For this reason, it is necessary that a pigment ink having an adequate viscosity or surface tension is used as the pigment ink for a light transmission filter. In general, a weight ratio of the pigment particle, which is a color material, is less than or equal to 10%. Water, alcohol, a volatile solvent, or the like is used as a main solvent component, a nonvolatile solvent which can be stably used by suppressing evaporation of the solvent component, a surfactant generating a surface tension or the like, and the like are added as a part of the solvent component. In general, the weight ratio of the pigment ink for a light transmission filter of greater than or equal to 90% is the solvent component. On the other hand, in a case where the concentration of the pigment particle, which is a solid component, increases, an image having a high concentration is easily obtained, but the viscosity of the pigment ink for a light transmission filter considerably increases, and thus, the refill performance or the like decrease, and it is difficult to perform high-speed printing, fixation, sedimentation, or the like easily occurs at the time of standing by the ink jet printing, and stability also decreases. For this reason, it is preferable that the weight ratio of the pigment particle is approximately less than or equal to 5%. In a case of using such a pigment ink for a light transmission filter having a low concentration, it is possible to increase a pigment print density by overstriking the pigment ink for a light transmission filter, but in an ink receiving layer of a single layer as with the related art, it is difficult to configure the ink receiving layer to have a sufficient film thickness such that a mass of pigment ink for a light transmission filter can be received, from the constraint such as the print resolution or the optical properties.

In response, in the ink jet color filter transfer material 1 of this embodiment, it is possible to improve the resolution and the light absorption properties by the pigment permeation layer, which is a thin film, and to have sufficient solvent absorption capacity for the solvent absorption layer, which is a thick film. For this reason, it is possible to stably perform overstriking printing with a high accuracy a plurality of times by using the pigment ink for a light transmission filter in which ink jet aptitude is increased by the pigment particle having a low concentration of a weight ratio of less than or equal to 5%. Accordingly, it is possible to stably form a pigment film having a high concentration and high definition by using the pigment ink for a light transmission filter in which the pigment particle has a low concentration. For example, even in a case where overstrike printing is performed a plurality of times by the pigment ink for a light transmission filter configured of a mass of solvent component having a weight ratio of greater than or equal to 95%, it is possible to absorb all of the solvent components by the solvent absorption layer having sufficient solvent absorption capacity, which is a thick film, without overflowing.

Further, the solvent absorption layer 1601 can be removed after being adhesively transferred to the image support 55, and thus, even in a case where the solvent absorption layer 1601 is formed as a sufficient thick film, a negative effect such as a haze reduction does not occur. That is, when the transfer material 1 of this embodiment is adhesively transferred to the image support 55, the pigment permeation layer 1600 is formed into a molten film by the pressurizing and heating treatment, and the large air gap of the pigment permeation layer 1600 is removed, and thus, it is possible to suppress the scattering of visible light in the pigment permeation layer 1600. Further, the solvent absorption layer 1601, which is a thick film, can be removed from the image support 55, and thus, it is possible to obtain a color filter having a small haze reduction and excellent optical properties. On image design of the pigment film, the adjacent pigment dots may overlap each other to bury each pixel, and the film thickness of the pigment permeation layer may be adjusted according to a desired amount of bleeding of the pigment dot.

As described above, in the transfer material 1 of this embodiment, the pigment ink for a light transmission filter is subjected to the solid-liquid separation by functionally separating the ink receiving layer into at least two layers, and all of the solvent components mainly configuring the pigment ink for a light transmission filter can be absorbed in the solvent absorption layer, which is a peelable thick film. For this reason, high-speed printing is performed with a high density by an ink jet printing method, and thus, even in a case where a mass of pigment ink for a light transmission filter is absorbed in the transfer material for a short period of time, it is possible to form a color filter having a high concentration and high definition without causing large bleeding in the color material.

(Formation of Pigment Permeation Layer into Molten Film and Removal of Solvent Absorption Layer)

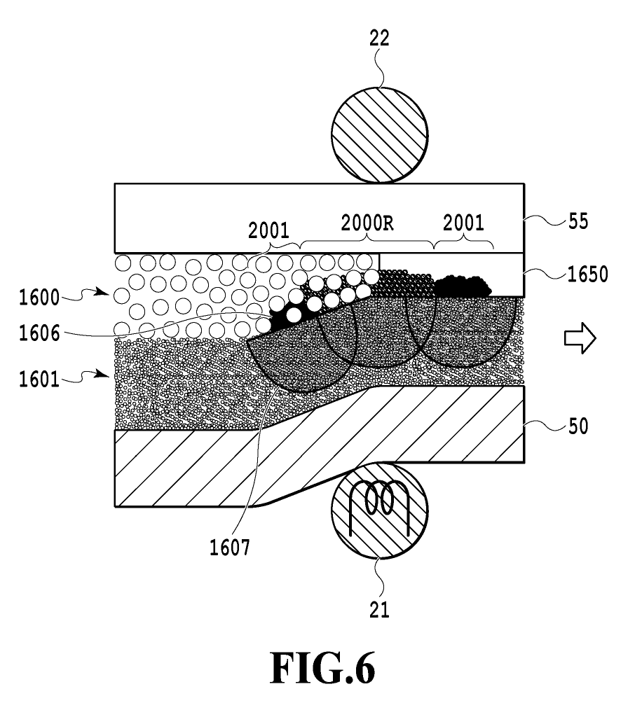

As illustrated in FIG. 6, the ink jet transfer material 1 for a color filter of this embodiment is subjected to the pressurizing and heating treatment by a heat roller 21 and a pressurizing roller 22 along with the image support 55, and thus, the pigment permeation layer 1600 is formed into a molten film and adheres to the image support 55. The pigment permeation layer 1600 is formed into a molten film to enclose the pigment film 1606 formed of a pigment particle 1003a by the heating and pressurizing treatment, and thus, it is possible to form the rigid pigment retention film 1650 on the image support 55. That is, the pigment retention film 1650 is formed into a molten film, and the air gap structure is eliminated, and thus, the pigment particle having excellent weatherability is prevented from being directly exposed to the outside, and each of the pigment particles is surely retained in an enclosed state. For this reason, it is possible for the color filter of this embodiment to stably maintain the optical properties over a long period.

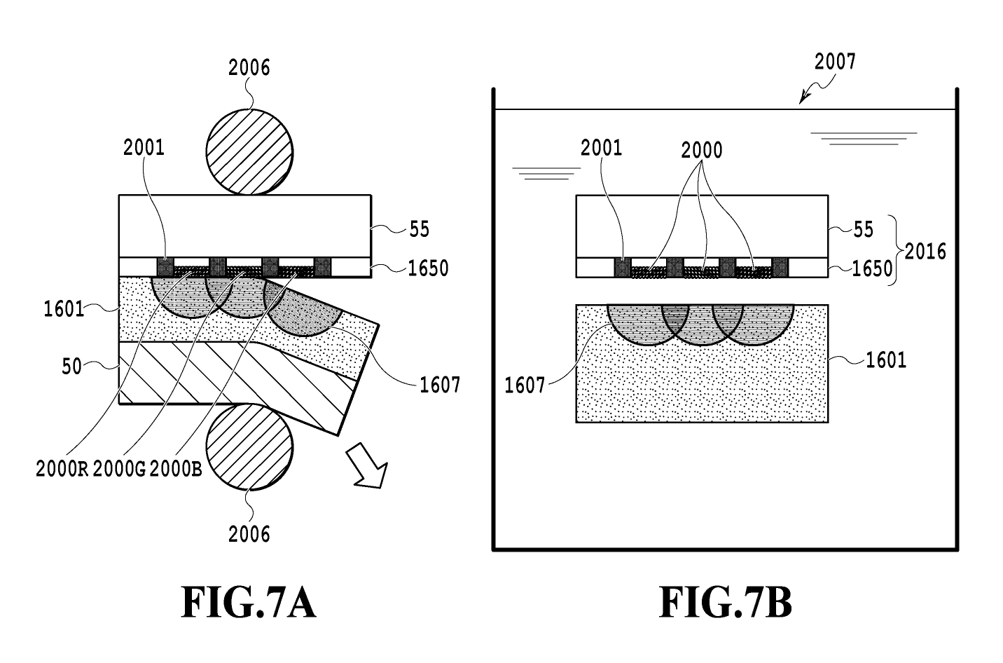

Next, illustrated in FIGS. 7A and 7B, the solvent absorption layer 1601 is peeled off and removed from the pigment retention film 1650 which adheres to the image support 55, and thus, an ink jet color filter transfer object 2016 having excellent light transmission absorption properties is obtained with high definition. That is, the solvent absorption layer 1601, which is a thick film, in which the air gap structure is maintained and a large amount of solvent component is absorbed, is removed after the adhesively transferring step of the heating and pressurizing treatment illustrated in FIG. 6, and thus, a haze reduction due to a large amount of solvent component or the solvent absorption layer 1601, which is a thick film, is considerably enhanced. For this reason, it is possible to obtain a color filter having excellent light transmission absorptivity. Furthermore, the solvent absorption layer 1601 can be mechanically peeled off and removed by a peeling roller 2006 illustrated in FIG. 7A. In addition, as illustrated in FIG. 7B, the solvent absorption layer 1601 can be peeled off and removed from the pigment retention film 1650, which adheres to the image support 55, by being immersed in a dedicated dissolution liquid 2007.

As described above, in the transfer material 1 of this embodiment, the pigment permeation layer 1600 is formed into a molten film by the pressurizing and heating treatment, and encloses the dense pigment film 1606 formed on the bottom of the pigment permeation layer 1600. For this reason, the pigment particle 1003a forming the pigment film 1606 can be completely immobilized, and the rigid pigment retention film 1650 can be formed. In addition, the pigment retention film is formed into a molten film and becomes transparent, and thus, it is possible to prepare the color filter transfer object 2016 having excellent optical properties.

### (Function as Peel-Off Layer of First Solvent Absorption Layer)

Further, the solvent absorption layer 1601 can also be formed into a plurality of layers having different air gap diameters. For example, as illustrated in FIG. 1E, FIG. 4A, and FIG. 5A, the solvent absorption layer 1601 can also be formed of the second solvent absorption layer 1612 having excellent solvent absorption properties, which is a thick film, and the first solvent absorption layer 1611 laminated on the second solvent absorption layer 1612, which is a thin film. In the illustrated solvent absorption layer 1601, the first solvent absorption layer 1611 is laminated on the second solvent absorption layer 1612 through the release layer 1701, which is a very thin film.

The pigment permeation layer 1600 has an air gap structure having an air gap diameter which is sufficiently larger than the pigment particle, but the first solvent absorption layer 1611 in contact with the pigment permeation layer 1600, is configured by using small particulates such that an air gap structure having an air gap diameter which is sufficiently smaller than the pigment particle, is formed. In addition, the second solvent absorption layer 1612 is configured by using smaller particulates such that an air gap structure having an air gap diameter which is smaller than the air gap diameter of the first solvent absorption layer 1611, is formed. For this reason, the capillary force of the first solvent absorption layer 1611, which is a thin film is sufficiently larger than that of the pigment permeation layer 1600, which is a thin film, and the second solvent absorption layer 1612, which is a thick film, generates a capillary force which is larger than that of the first solvent absorption layer 1611, which is a thin film.

Accordingly, the pigment ink for a light transmission filter printed on the pigment permeation layer 1600 is subjected to the solid-liquid separation on the interface with respect to the first solvent absorption layer 1611 at a high speed, and approximately all of the solvent components 1607 are started to be absorbed in the first solvent absorption layer 1611 while the thin and dense pigment film 1606 is formed on the bottom of the pigment permeation layer 1600. In a case where a tip end of the solvent component 1607 absorbed in the first solvent absorption layer 1611, which is a thin film, reaches the interface between the first solvent absorption layer 1611 and the second solvent absorption layer 1612, which is a thick film, the solvent component 1607 is started to be sequentially and rapidly absorbed on the second solvent absorption layer 1612 side where a larger capillary force is generated. Then, finally, approximately all of the solvent components 1607 are absorbed in the second solvent absorption layer 1612, which is a thick film. For this reason, the solvent component 1607 rarely remains in the pigment permeation layer 1600, which is formed into a molten film, and the first solvent absorption layer 1611. Accordingly, it is possible to perform the adhesive transfer with respect to the image support 55 by the pressurizing and heating treatment immediately after the pigment ink for a light transmission filter is applied to the transfer material by the ink jet printing.

The second solvent absorption layer 1612 absorbing approximately all of the solvent components 1607, which is a thick film, is peeled off and removed through the release layer 1701, after a transfer object is adhesively transferred to the image support 55. Accordingly, it is possible to obtain the color filter transfer object 2016 formed of the image support 55, the rigid pigment retention film 1650 which is formed into a molten film to enclose the pigment film 1606 and is adhesively transferred to the image support 55, and the first solvent absorption layer 1611, which is a thin film. The first solvent absorption layer 1611, which is a thin film, may have an air gap which is smaller than the pigment particle, and thus, can be configured by using particulates which are sufficiently smaller than a visible light wavelength. For this reason, in the transfer object 2016, the light scattering in the visible light of the air gap structure is small, and a haze reduction can be suppressed. The first solvent absorption layer 1611 still retains the air gap structure, but is capable of functioning as a mechanical protective layer of the pigment retention film 1650.

The first solvent absorption layer 1611 which is not formed into a molten film by pressurizing and heating, is also capable of functioning as a peel-off layer of the second solvent absorption layer 1612. The air gap structure of the first solvent absorption layer 1611 is configured by connecting the particulates to each other with a bonding resin, and thus, in a case where the ratio of the bonding resin decreases, a cohesive failure of the particulates easily occurs. For this reason, the air gap structure of the first solvent absorption layer 1611 is configured by increasing the air gap diameter of the air gap structure and a ratio of particulates/bonding resin by using particulates which are slightly larger than those of the second solvent absorption layer 1612. According to this, when the second solvent absorption layer 1612 is peeled off from the pigment retention film 1650 adhesively transferred to the image support 55, the first solvent absorption layer 1611 causes an interlayer cohesive failure, and functions as a peel-off layer. The particulates of the first solvent absorption layer 1611 are connected to the bonding resin of the pigment permeation layer 1600 on the interface with respect to the pigment permeation layer 1600, and thus, easily remain on the pigment permeation layer side when a cohesive failure occurs, and the remaining pigment permeation layer is a very thin layer, but also functions as a mechanical protective layer.

### (Use for Transparent Protective Film of First Solvent Absorption Layer)

Further, the first solvent absorption layer is configured by using the same material as that of the pigment permeation layer, and resin particulates which are smaller than the resin particulates used in the pigment permeation layer, and thus, is capable of removing the air gap structure by being formed into a molten film by the pressurizing and heating treatment. In a case where the transfer material 1 forming the pigment film 1606 overlaps with the image support 55 illustrated in FIG. 4A and FIG. 5A, and then, is subjected to the pressurizing and heating treatment by the heat roller 21 and the pressurizing roller (FIG. 6), the first solvent absorption layer 1611 is also formed into a molten film simultaneously with the pigment permeation layer 1600. Accordingly, the rigid pigment retention film 1650 on which the pigment film 1606 is formed, and the transparent protective film 1660 in which the first solvent absorption layer 1611 is formed into a molten film, are transferred to the image support 55. Subsequently, the second solvent absorption layer 1612 retaining an air gap structure is peeled off and removed, and thus, it is possible to obtain the color filter transfer object 2016 from which the air gap structure of at least a part of the solvent absorption layer is removed.

In the color filter transfer object 2016 illustrated in FIG. 4B and FIG. 5B, the transparent protective film 1660 having a small haze reduction, from which the air gap structure of the first solvent absorption layer 1611 is completely eliminated, is formed on a front layer. The transparent protective film 1660 completely prevents the pigment particle of the pigment retention film 1650 from being exposed to the outside, and a mechanical strength of an image front surface is improved. Further, transparent protective film 1660 blocks entry of toxic stimulant light, a pollutant liquid, toxic gas, or the like from a front surface or an end surface of the filter transfer object 2016, and thus, it is possible to reduce a pollution and a deterioration in the pigment particle, which is a color material. For this reason, the color filter transfer object 2016 has excellent pigment film storage stability for a long period. In addition, as illustrated in FIG. 7B, in a case where the second solvent absorption layer 1612 is subjected to dissolution washing by the dedicated solvent 2007, the transparent protective film 1660 in which the first solvent absorption layer 1611 is formed into a transparent protective film, protects the pigment retention film, and thus, the color filter transfer object 2016 is not polluted by the dedicated solvent 2000.

### (Disuse of Image Support)

In the above description, an example has been described in which the light transmission filter is manufactured by using the image support 55, but it is also possible to manufacture the light transmission filter without using the image support 55. That is, the pigment ink for a light transmission filter is applied to the transfer material 1 where the pigment permeation layer 1600, which can be formed into a molten film, and the solvent absorption layer 1601, which can be formed into a molten film, are laminated, by the ink jet printing apparatus, and then, the solvent component absorbed in the solvent absorption layer is dried by a drying device, and then, the heating and pressurizing treatment is performed by the heat roller, the heating plate, or the like, including a releasable front surface. Accordingly, the pigment permeation layer 1600 and the solvent absorption layer 1601 are formed into a molten film. Accordingly, it is possible to obtain the pigment retention film 1650 in which the pigment permeation layer 1600 is formed into a molten film, the pigment film 1606 formed of the pigment particle 1003a included in the pigment retention film 1650, and the light transmission filter in which a rear surface protective film formed of the solvent absorption layer, which is a thick film, is formed into a molten film. As a result thereof, the air gap structure of the pigment permeation layer 1600 and the solvent absorption layer 1601 is eliminated, and thus, a film-like light transmission filter having a small haze reduction, in which the front and the rear are formed into a transparent film, is formed. Alternatively, the ink jet printing is performed by using the transfer material in which the pigment permeation layer 1600, which can be formed into a molten film, and the first solvent absorption layer 1611, which can be formed into a molten film, and the second solvent absorption layer 1612, which is a thick film, may be laminated, and then, a molten film may be formed, and then, the second solvent absorption layer 1612 may be removed. It is possible to obtain the pigment retention film 1650 in which the pigment permeation layer 1600 is formed into a molten film, the pigment film 1606 formed of the pigment particle 1003a included in the pigment retention film 1650, and the light transmission filter formed of the rear surface transparent protective film 1660 in which the first solvent absorption layer 1611 is formed into a molten film, which is an extremely thin film. That is, the multi-layered air gap type ink receiving layer which is necessary at the time of performing the ink jet printing, is formed into a molten film, is peeled off, or is dissolved and removed, and the air gap structure is eliminated, and thus, it is possible to improve light transmissivity. Further, the pigment permeation layer is formed into a molten film, and thus, it is possible to securely retain the thin and dense pigment film, to utilize the front layer as an adhesively transferred layer with respect to the image support, and to allow the pigment permeation layer to function as a transparent protective film even in a case of not being transferred to the image support. In addition, the entire or a part of the solvent absorption layer remains by being formed into a molten film, and thus, is capable of functioning as the rear surface transparent protective film of the pigment film. Furthermore, the light transmission filter has a low mechanical strength and is easily broken, and thus, it is necessary to note the handling of sticking the light transmission filter to a display element.

### (Adhesion Reinforcement (Addition of Patchy Adhesive Agent))

In an aspect where the transfer material 1 for a color filter including the pigment permeation layer 1600 which is formed into a molten film by the pressurizing and heating treatment, and the solvent absorption layer 1601 is adhesively transferred to the image support 55, in order to reinforce the adhesion between the pigment permeation layer 1600 and the image support 55, an adhesive agent may be used. A use example of the adhesive agent is illustrated in FIG. 5A. In the illustrated example, a resin material which can be melted by pressurizing and heating and hardly absorbs the pigment ink for a light transmission filter is discretely provided on the front surface of the pigment permeation layer 1600 as an adhesive agent 1000B. At this time, the adhesive agent 1000B is patchily and discretely configured such that an exposed portion 1001 remains in which the pigment permeation layer 1600 is directly exposed. The adhesive agent 1000B may be in the shape of a cubical film, but it is more preferable that the adhesive agent 1000B is in the shape of a particle which is larger than the air gap of the pigment permeation layer 1600 such that a contact area with respect to the front surface of the pigment permeation layer decreases. In addition, in consideration of the permeation of the pigment ink for a light transmission filter in the planar direction in the pigment permeation layer 1600, it is preferable that a width in which each adhesive agent 1000B is in contact with the pigment permeation layer 1600 is less than two times the film thickness of the pigment permeation layer 1600.

As illustrated in FIG. 8A, the pigment ink for a light transmission filter 1003 landed on a region 1001 in the front surface of the pigment permeation layer 1600, to which the adhesive agent 1000B is not applied, is rapidly absorbed in the pigment permeation layer 1600. On the other hand, as illustrated in FIG. 8B, the pigment ink for a light transmission filter 1003 landed on the adhesive agent 1000B is not absorbed in the adhesive agent 1000B, but flows into the pigment permeation layer 1600. Then, a part of the ink droplet of the pigment ink for a light transmission filter 1003 is in contact with the exposed portion 1001 in which the pigment permeation layer 1600 is exposed, and thus, all of the ink droplets of the pigment ink for a light transmission filter 1003 are rapidly dragged in the pigment permeation layer 1600 having an air gap structure.

In addition, as illustrated in FIG. 8B, in the pigment permeation layer 1600, the pigment ink for a light transmission filter 1003 is diffused and permeates not only in the film thickness direction but also in a film planar direction, and thus, the pigment ink for a light transmission filter 1003 can also be moved around to an area immediately below the adhesive agent 1000B. For this reason, the pigment image (pigment film) 1606 having a high concentration, in which a white point, which is a non-image portion, is prevented from being generated, can be formed on the bottom of the pigment permeation layer 1600.

That is, the pigment ink for a light transmission filter permeates and is diffused in the pigment permeation layer 1600 by a capillary force in the air gap structure of the pigment permeation layer 1600, and thus, the pigment particle 1003a is capable of entering the area immediately below the adhesive agent 1000B which hardly absorbs the pigment ink for a light transmission filter 1003, and an area factor can be improved. The pigment ink for a light transmission filter 1003 which is absorbed and permeates in the pigment permeation layer 1600, is absorbed while spreading in the film thickness direction and the planar direction, according to the permeation anisotropy of the pigment permeation layer 1600. Design and film production may be performed such that the permeation anisotropy of the pigment permeation layer 1600 such that spread of ink dots, which is the foundation of the image design of the ink jet printing, can be suitably controlled. That is, in a case where large ink dots are required, the permeation in the planar direction may be higher than the permeation in the film thickness direction, whereas in a case where small ink dots are required, the permeation in the planar direction may be higher than the permeation in the film thickness direction, and the film thickness of the pigment permeation layer 1600 may be adjusted.

In a case where the permeation of the pigment ink for a light transmission filter 1003 of the pigment permeation layer 1600 is isotropic, the dots spread in a width approximately corresponding to the thickness of the pigment permeation layer 1600. Accordingly, in a case where the width in which each of the adhesive agents are in contact with the pigment permeation layer 1600, is less than two times the film thickness of the pigment permeation layer 1600, it is possible to prevent a white point from being generated in the area immediately below the adhesive agent. In a case where an area in which the adhesive agent is in contact with the pigment permeation layer 1600 is small, the adhesive agent may be in the shape of a particle, or the adhesive agent in the shape of a film may be discretely provided.

In addition, it is preferable to select a resin material which hardly absorbs the pigment ink for a light transmission filter, as the resin material configuring the adhesive agent such that the pigment ink for a light transmission filter landed on the adhesive agent is capable of rapidly reaching the front surface of the pigment permeation layer through the front surface of the adhesive agent. For example, it is preferable to use an adhesive agent which rarely holds the pigment ink for a light transmission filter, is formed of a material flowing to slide on the front surface, is formed in the shape of a grain in which the contact area with respect to the pigment permeation layer is small, and has a large volume. In addition, it is preferable that the interval of each of the adhesive agents patchily and discretely set to be larger than the size of the ink droplet of the pigment ink for a light transmission filter such that the ink droplet of the landed pigment ink for a light transmission filter 1003 is not temporarily straddle and held between the adhesive agents in the shape of a bridge.

In addition, the pigment film 1606 is formed, and then, the transfer material 1 for a color filter of this embodiment subjected to the pressurizing and heating treatment in a state of overlapping with the image support 55, and thus, both of the pigment permeation layer 1600 and the adhesive agent 1000B are formed into a molten film, and are adhesively transferred to the image support. It is not necessary to consider the absorptivity of the pigment ink for a light transmission filter 1003, but the resin material to be used in the adhesive agent 1002 may be selected on the basis of improvement in the adhesion with respect to the various image supports and the pigment permeation layer 1600 which is formed into a molten film. For example, the resin material of the adhesive agent may be selected according to the type of image support such as a glass front surface or a metal front surface which hardly adheres only with the pigment permeation layer 1600 which is formed into a molten film. In addition, the adhesive agent may be configured of a plurality of types of resin materials such that an effect as the adhesive agent (an improving effect of adhesive transfer properties) is exhibited with respect to various image supports.

As illustrated in FIG. 5A, the patchily provided adhesive agent is formed into a molten film along with the pigment permeation layer, and thus, a strong adhesive portion can be formed, and the pigment retention film 1650 can be rigidly and adhesively transferred to the image support 55. That is, in a case where the adhesive agent having excellent adhesion is formed into a molten film, and a discretely adhesive reinforcement portion 1704 as illustrated in FIG. 5B is formed between the pigment retention film 1650 and the image support 55 such as glass, adhesive transfer properties of the pigment retention film 1650 and the image support 55 can be considerably improved. Further, in a case where a volume at the time of being melted is sufficiently ensured by using an adhesive agent having a large particle size, and an adhesive reinforcement film is formed over the entire surface of the image support 55 and the pigment retention film 1650, the image support 55 can be more rigidly and adhesively transferred to the pigment retention film 1650.

As described above, the adhesive agent is patchily and discretely provided on the front surface of the pigment permeation layer 1600, and thus, it is possible to provide the transfer material 1 for a color filter which has excellent adhesive transfer properties with respect to various image supports, does not generate a white point, and has excellent adhesive transfer properties and print properties.

### (Adhesion Reinforcement (Addition of Sea-and-Island-Like Adhesive Layer))

Another use example of the adhesive agent for increasing the adhesion between the image support 55 and the pigment permeation layer 1600 is illustrated in FIG. 4A. In this example, as illustrated in FIG. 4A, an adhesive agent 1000A which is capable of being melted and adhering by pressurizing and heating, and rarely absorbs the pigment ink for a light transmission filter, is discretely distributed on the front surface of the pigment permeation layer 1600, into the shape of a fine island. As a result thereof, the exposed portion 1001 in which the front surface of the pigment permeation layer 1600 is exposed is in a state of remaining in the shape of a sea. Thus, in this example, an enhanced adhesive layer 1012, in which the exposed portion 1001 and the adhesive agent 1000A are provided in the shape of sea-and-island, is disposed on the pigment permeation layer 1600.

In the pigment permeation layer 1600 where the adhesive agent is provided in the shape of sea-and-island, in a case where the ink droplet of the pigment ink for a light transmission filter is landed on the adhesive agent 1000A, the ink droplet is deformed due to land impact, and a part of the pigment ink for a light transmission filter flows to the sea-like exposed portion 1001. A liquid flowing into the exposed portion 1001 is in contact with the front surface of the pigment permeation layer 1600 having an air gap structure, and is started to be smoothly absorbed in the pigment permeation layer 1600. In order to facilitate the ink droplet landed on the adhesive agent 1000A to be in contact with the pigment permeation layer 1600, it is preferable that an aggregate of pieces of the adhesive agent 1000A or the adhesive agent is configured not to be significantly larger than the ink droplet of the pigment ink for a light transmission filter. It is more preferable that the aggregate of pieces of the adhesive agent 1000A is finely provided to be smaller than the size of the ink droplet.

Thus, it is important that the adhesive agent 1000A or the adhesive agent is provided such that the exposed portion of the pigment permeation layer 1600, which is a base point of ink absorption, is formed at a suitable interval. Specifically, a sea-and-island-like enhanced adhesive layer 2002 may be configured by providing an aggregate of pieces of the fine island-like adhesive agent 1000A or the adhesive agent such that at least one or more exposed portion 1001 of the pigment permeation layer, which is a sea portion, exists in one pixel of the ink jet printing to be assumed.

According to this example, in the sea-and-island-like enhanced adhesive layer, the amount of adhesive agent can be more even, and a larger amount of adhesive agent can be applied, and thus, it is possible to further improve the adhesion, compared to the patchily provided adhesive agent. That is, the interval of the aggregate of pieces of the adhesive agent 1000A or the adhesive agent configuring the enhanced adhesive layer 2002 can be more finely set, and thus, when the pigment permeation layer 1600 is formed into a molten film, discretely provided adhesive agents are easily in connect with each other. For this reason, approximately even adhesive reinforcement film can be formed over the entire surface between the pigment retention film 1650 and the image support 55, a variation in an adhesive state with respect to the image support 55 is reduced, and adhesive stability is improved. As with the adhesive agent in a case of being patchily provided, resin particulates of a material which hardly absorbs the pigment ink for a light transmission filter can be used as a particle-shaped adhesive agent used in the sea-and-island-like enhanced adhesive layer. However, it is necessary that a particle diameter is smaller than that of the patchy adhesive agent.

In addition, in the pigment permeation layer 1600, the pigment ink for a light transmission filter permeates and is diffused not only in the film thickness direction and but also in the planar direction due to a capillary effect of the air gap structure. Accordingly, a width in which the condensation of pieces of each of the adhesive agents 1000A or the adhesive agents which are provided in the shape of an island covers the front surface of the pigment permeation layer 1600, is configured to be less than two times the film thickness of the pigment permeation layer, and thus, the pigment ink for a light transmission filter can also be moved around to the area immediately below the adhesive agent. More preferably, the aggregate of pieces of the particle-shaped adhesive agent 1000A or the adhesive agent may be provided such that the width in which the front surface of the pigment permeation layer is covered with the condensation of pieces of each of the adhesive agents 1000A or the adhesive agents is smaller than the film thickness of the pigment permeation layer.

Thus, by using the permeation and diffusion in the pigment permeation layer 1600, the pigment ink for a light transmission filter is capable of permeating even in a portion where the front surface of the pigment permeation layer 1600 is covered with the adhesive agent and in the pigment permeation layer 1600 below the portion, and of being moved around thereto. Accordingly, in a case where the permeation, the film thickness, and the like of the pigment permeation layer are suitably adjusted according to the disposition and the structure of the adhesive agent 1000A, it is possible to reduce a white point as a fine non-image portion which is easily generated in the area immediately below the adhesive agent, and it is possible to form a dense pigment image over the entire pigment permeation layer.

### (Adhesion Reinforcement (Plurality of Pigment Permeation Layers))

In order to increase the adhesion between the image support 55 and the pigment permeation layer 1600, as illustrated in FIG. 1C, it is effective to form the pigment permeation layer 1600 into a plurality of layers. The pigment permeation layer 1600 in each of the drawings, is formed by laminating the second pigment permeation layer 1680 having excellent adhesion with respect to the image support 55, which is a thin film, is laminated on the front surface of the first pigment permeation layer 1670. That is, unlike the first pigment permeation layer 1670 which retains the pigment film 1606 to be enclosed at the time of being formed into a molten film, the second pigment permeation layer 1680 which is configured of a material having excellent adhesion with respect to the image support and has a large air gap is provided. Accordingly, adhesive transfer properties with respect to the image support 55 can be reinforced by the second pigment permeation layer 1680.

The material of the second pigment permeation layer 1680 may be selected on the basis of affinity and adhesion with respect to various image supports 55, and affinity and adhesion with respect to the first pigment permeation layer 1670 which is formed into a molten film. For example, the second pigment permeation layer 1800 may be configured by selecting a resin material according to the type of the image support 55 to be used, such as a glass front surface, which hardly adheres only with the resin material. Accordingly, excellent adhesive transfer properties can also be obtained with respect to various image supports 55.

In addition, the second pigment permeation layer 1680 has an air gap which is larger than that of the first pigment permeation layer 1670, and thus, has a small capillary force. Accordingly, in consideration of the permeation of the pigment ink for a light transmission filter 1003, it is preferable that the second pigment permeation layer 1680 is configured as a thin film which is thinner than the first pigment permeation layer 1670. The ink droplet of the pigment ink for a light transmission filter 1003, which is landed on the front surface of the second pigment permeation layer 1680, rapidly permeates due to the air gap structure of the second pigment permeation layer 1680. In a case where the tip end of the ink permeating in the second pigment permeation layer 1680 reaches the interface with respect to the first pigment permeation layer 1670 having a small air gap, the tip end of the ink is started to be absorbed in the first pigment permeation layer 1670 which has a slight small air gap and a slightly large capillary force. At this time, in the second pigment permeation layer 1680 having a large air gap, flow path resistance is small, the subsequent pigment ink for a light transmission filter 1003 is also started to be absorbed in the first pigment permeation layer 1670 without being torn. That is, the first pigment permeation layer 1670 has an air gap which is sufficiently larger than the pigment particle 1003a, and thus, a large capillary force is hardly generated, but the flow path resistance is small, and thus, the pigment ink for a light transmission filter 1003 printed on the front surface of the second pigment permeation layer 1680 having a small air gap structure, which is a thinner film, smoothly permeates and is smoothly absorbed in the first pigment permeation layer 1670, which is a thin film, along with the pigment particle 1003a.

On the other hand, the air gap structure of the solvent absorption layer 1601 is an air gap structure having a pore which is sufficiently smaller than that of the pigment particle 1003a, and thus, a capillary force is significantly large. In addition, the air gap is smaller than the pigment particle 1003a and flow path resistance is large, and thus, the pigment particle 1003a is subjected to the solid-liquid separation on the interface between the solvent absorption layer 1601 and the first pigment permeation layer 1670, and only the solvent component 1607 of the pigment ink for a light transmission filter 1003 is rapidly absorbed in the solvent absorption layer 1601. That is, in a case where a part of the pigment ink for a light transmission filter 1003 which has been subjected to the absorption and permeation from the front surface of the second pigment permeation layer 1680 to the first pigment permeation layer 1670, reaches the interface between the solvent absorption layer 1601 and the first pigment permeation layer 1670, the solvent component 1607 of the pigment ink for a light transmission filter 1003 is started to be rapidly absorbed according to a significantly large capillary force of the solvent absorption layer 1601. For this reason, the subsequent pigment ink for a light transmission filter 1003 in the second pigment permeation layer 1680 or the first pigment permeation layer 1670 is also sequentially and rapidly absorbed in the solvent absorption layer 1601. That is, the pigment ink continuously permeates in the solvent absorption layer 1601 without being torn, according to the viscosity and the surface tension of the ink. Then, finally, approximately all of the solvent components of the pigment ink for a light transmission filter applied to the pigment permeation layer 1600 are absorbed and retained in the solvent absorption layer 1601. Accordingly, even in a case of the pigment permeation layer 1600 which is formed of a plurality of layers and has a comparatively small capillary force, it is possible to reduce holding time of the solvent component 1607 of the pigment ink for a light transmission filter 1003. In addition, approximately all of the solvent components of the pigment ink for a light transmission filter applied to the pigment permeation layer 1600 are absorbed in the solvent absorption layer 1601, and thus, the solvent component 1607 rarely remains in the pigment permeation layer 1600. Accordingly, an image is formed by the ink jet printing, and then, even in a case where the pressurizing and heating treatment is performed without specially providing a drying unit or drying time, excellent adhesion can be maintained in the melted pigment permeation layer 1600. That is, even immediately after the ink jet printing, an adhesive transfer treatment can be rapidly started with respect to the image support 55.

In addition, even in a case where the pigment permeation layer 1600 is formed into a molten film by the pressurizing and heating treatment, the solvent absorption layer 1601 which absorbs and retains the solvent, maintains the air gap structure, and thus, reverse flow or seep out of the solvent component 1607 from the solvent absorption layer 1601 does not occur. Accordingly, adhesion of a transfer body 1G does not decrease due to the solvent component after the transfer body 1G adheres to the image support 55. Further, the pigment particles 1003a are subjected to the solid-liquid separation on the interface between the first pigment permeation layer 1670 and the solvent absorption layer 1601 while being thinly and densely compressed through the second pigment permeation layer 1680 without remaining therein. For this reason, it is possible to form the pigment image (pigment film) 1606 having a high concentration and high definition on the bottom of the first pigment permeation layer 1670, which is a thin film.

In addition, a resin material different from that of the first pigment permeation layer 1670 is used as the resin material of the second pigment permeation layer 1680, on the basis of improvement in the adhesion between the various image supports and the first pigment permeation layer 1670. For this reason, in the transfer material of this example, the first and the second pigment permeation layers 1670, 1680 function as an adhesive reinforcement film, and a rigid adhesive state can be obtained, with respect to an image support such as a glass front surface or a metal front surface in which a rigid adhesive state is hardly obtained by only the first pigment permeation layer 1670, which is a thin film.

### (Relationship Between Pigment Particle Magnitude and Air Gap Diameter (Improvement in Versatility of Transfer Material))

The pigment ink for a light transmission filter can be applied to the transfer material 1 by using various ink jet printing apparatuses. In the pigment ink for a light transmission filter 1003, the pigment particles 1003a, which are a color material, are evenly dispersed in the solvent component 1607 where water as a main component, a volatile solvent, a nonvolatile solvent as an additive, and the like are mixed.

In the transfer material 1 of this example, the air gap structure of the solvent absorption layer 1601 formed into a thick film is configured of a pore which is sufficiently smaller than the pigment particle 1003a, and the air gap structure of the pigment permeation layer 1600, which is a thin film, is configured of an air gap diameter which is sufficiently larger than the pigment particle 1003. Accordingly, an ink absorption mechanism is realized in which the pigment particle 1003a is subjected to the solid-liquid separation on the interface between the pigment permeation layer 1600 and the solvent absorption layer 1601, the thin and dense pigment image is formed on the bottom of the pigment permeation layer 1600, and approximately all of the solvent components are rapidly and sequentially absorbed in the solvent absorption layer 1601. Accordingly, in order to correspond to various ink jet printing apparatuses, it is necessary to configure the pigment permeation layer 1600 having an air gap sufficiently larger than the pigment particle 1003a having the largest particle size, which is a thin film, in the pigment ink for a light transmission filter 1003 which is assumed to be used. Further, it is necessary to configure the solvent absorption layer 1601 of a layer having an air gap sufficiently smaller than the pigment particle 1603 having the smallest particle size, which is thick film. Further, it is preferable that the pigment permeation layer 1600 is designed to be a thin film, on the basis of the adhesive transfer properties with respect to the various image support. In addition, in the solvent absorption layer 1601, it is not necessary to concern a decrease in the resolution due to excessive bleeding. Accordingly, it is possible to design the pigment permeation layer 1600 as a thick film on the basis of solvent absorptivity, such that a large capillary force and sufficient solvent absorption capacity can be obtained.

That is, the transfer material according to the invention can also be used in an ink jet printing apparatus for a large pigment particle and in an ink jet printing apparatus for a small pigment particle, and thus, a broad-ranging ink jet printing apparatus can be applied to the transfer material.

As described above, the transfer material according to the invention is configured by laminating the air gap absorption type solvent absorption layer having excellent ink solvent absorptivity, which is a thick film, and the air gap absorption type pigment permeation layer which is a thin film and is capable of adhering to the image support by being formed into a molten film due to elimination of the air gap structure according to the pressurizing and heating. The air gap structure of the solvent absorption layer is configured of a pore which is sufficiently smaller than the pigment particle, and the air gap structure of the pigment permeation layer is configured by an air gap diameter which is sufficiently larger than the pigment particle. In addition, the ink jet printing of the pigment ink for a light transmission filter is performed by using various ink jet printing apparatuses, and then, overlapping with various image supports is performed by using an adhesive transfer device, and thus, the pressurizing and heating treatment is performed. Accordingly, the pigment permeation layer on which the pigment film is formed, is formed into a molten film, and is adhesively transferred to the image support while forming the pigment retention film, and after that, the solvent absorption layer in which the solvent component is absorbed by maintaining the air gap structure, is removed, and thus, it is possible to prepare a filter transfer object having excellent light transmission absorption properties with high definition.

### (Manufacturing Method of Transfer Material)

### <Film Formation of Solvent Absorption Layer, and Preparing Method and Material of Solvent Absorption Layer>

The solvent absorption layer 1601 of the transfer material for a color filter of the invention is formed into a thick film in order to rapidly absorb a large amount of the solvent component, which is the liquid component of the pigment ink for a light transmission filter, according to a function of a capillary phenomenon due to a pore structure which is sufficiently smaller than the pigment particle 1003a. Accordingly, a material which is capable of sufficiently absorbing the solvent component in the air gap structure, has a sufficient thickness excellent for conveying performance or handling properties, and includes a pore formed therein, which has a size sufficiently smaller than that of the pigment particle, may be used as a material in a case of forming the solvent absorption layer 1601 itself into a sheet-like film. Examples of the solvent absorption layer 1601 having a pore structure include a transparent resin composite film which is a composite of a transparent sheet or a cellulose nanofiber subjected to papermaking by performing a chemical treatment with respect to a cellulose nanofiber, and a resin. In addition, a film may be used in which a fine pore is formed by performing a hydrothermal reaction with respect to a raw material of diatom earth containing silicon dioxide (SiO2) as a main component. Alternatively, a film in which polyvinylidene fluoride, polystyrene, polyethylene, polypropylene, polyester, polyamide, and the like are subjected to a craze treatment or calcium carbonates are dispersed, can be used by being subjected to stretching processing. For example, a porous solvent absorption layer obtained by performing stretching processing with respect to a film in which calcium carbonates are dispersed by containing polyethylene as a main component, is further subjected to stretching processing, and thus, it is possible to manufacture a porous solvent absorption layer. Alternatively, a pore structure may be formed on the solvent absorption layer by craze processing. In the craze processing, a film is replicated at a predetermined angle approximately in parallel with a molecular orientation direction, and is pulled while applying a pressure to an upper surface and a lower surface. Accordingly, a molecule flux (a fibril) and a pore (a void) are formed, are partially connected to each other, and thus, it is possible to form a penetrating pore such that a sponge structure is formed as a whole. At this time, in a case where the thickness of solvent absorption layer is set to 20 μm to 300 μm, excellent conveying performance can be obtained.

### <Substrate>

In the transfer material for a filter of this embodiment, in order to improve conveying performance at the time of performing the ink jet printing, and to improve handling properties at the time of performing the adhesive transfer, the ink receiving layer 16 may be formed by sequentially laminating a plurality of layers on the sheet-like substrate 50. That is, the ink receiving layer 16 such as the solvent absorption layer 1601 or the pigment permeation layer 1600 is sequentially disposed on the substrate 50, and thus, it is possible to improve productivity at the time of producing each film. In a case of disposing the substrate 50, the substrate 50 may be removed along with the solvent absorption layer by performing a removing treatment such as peeling off or dissolution washing, after being adhesively transferred to the image support 55. The substrate 50 has a function as a conveying layer which suppresses curling of the transfer material 1 and has excellent conveying performance at the time of performing image printing of forming a color filter image. In addition, in order to further improve the conveying performance of the substrate 50 or to enhance sliding capability, a known conveyance assist layer or the like may be disposed on the rear surface side. In addition, in the substrate 50, any one of a transparent material, an opaque material, and a chromatic material can be selected.

There are many cases that polyethylene terephthalate (PET) is used as a preferred material of the substrate 50, from the viewpoint of mechanically properties and thermal properties. A resin configuring the substrate 50 may be suitably selected according to the application of the transfer material for a filter, and various materials can be used. In a case where the substrate is in the shape of a roll, the thickness of the substrate is preferably set to be greater than or equal to 5 μm and less than or equal to 100 μm, is more preferably set to be greater than or equal to 15 μm and less than or equal to 50 μm, and thus, it is possible to improve the conveying performance of the transfer material for a filter. In contrast, in a substrate suitable for configuring a cut sheet or a plate-like transfer material 1 for a filter, it is preferable that a thick substrate having excellent mechanical strength or hardness is used as the conveying layer, from the viewpoint of curling resistance, sheet feeding capability, or the like. The thickness of the substrate 50 may be preferably greater than or equal to 30 μm and less than or equal to 300 μm, and may be more preferably greater than or equal to 50 μm and less than or equal to 200 μm.

Thus, the thickness of the substrate 50 may be suitably determined in consideration of the conveying performance or the material strength of the transfer material 1 to be configured. Furthermore, in the pressurizing and heating treatment in the adhesively transferring step, as illustrated in FIG. 6, the substrate side is heated, and the heat is transmitted to the solvent absorption layer 1601 through the solvent absorption layer 1601, and thus, the pigment permeation layer 1600 can be formed into a molten film. In this case, a pressurizing and heating condition may be adjusted in consideration of heat resistance of the pigment permeation substrate 50. In addition, the pigment permeation layer 1600 can be formed into a molten film by performing the heating from the image support 55 side such as a thin film-like glass plate or resin film.

(Air Gap Diameter and Film Thickness for Performing Solid-Liquid Separation with Respect to Pigment Particle)

A water-soluble resin containing inorganic particulates having the a particle size smaller than or equal to that of the pigment particle 1003a of the pigment ink for a light transmission filter 1003 is laminated on the substrate 50, and thus, it is possible to form the solvent absorption layer 1601 having an air gap which is sufficiently smaller than the pigment particle 1003a. According to the solvent absorption layer 1601, the solvent component 1607 of the pigment ink for a light transmission filter is absorbed, and the entry of the pigment particle 1003a is inhibited, and thus, the pigment ink for a light transmission filter 1003 can be subjected to the solid-liquid separation. In addition, in a case where the solvent absorption layer 1601 is formed into a thick film, the size of the resin particulates can be determined to be sufficiently smaller than the pigment particle 1003a of the pigment ink for a light transmission filter 1003 ejected from an ink jet printing apparatus.

According to the consideration of the present inventors, it is preferable that the average of pore diameters (an average pore diameter) of the air gap absorption type solvent absorption layer configured of the inorganic particulates and the water-soluble resin is approximately 5 nm to 100 nm. In a case where the average pore diameter is less than 5 nm, sufficient ink absorption capacity is not obtained unless the solvent absorption layer is considerably thick, and thus, there is a concern that the ink overflows, and the unabsorbed ink solvent remains in the solvent absorption layer 1601. In addition, in a case where the average pore diameter is greater than 100 nm, the pigment particle 1003a is not sufficiently subjected to the solid-liquid separation on the interface with respect to the solvent absorption layer 1601, and permeates and is diffused even in the solvent absorption layer, and thus, there is a case where the coloring capability or the resolution of the image is not sufficiently obtained.

The particle diameter of the inorganic particulates and the water-soluble resin used in the solvent absorption layer 1601 is not particularly limited insofar as the average pore diameter is approximately 5 nm to 100 nm as described above. Inorganic particulates having a primary particle diameter of 5 nm to 100 nm and an aggregated secondary particle diameter of approximately 20 nm to 500 nm are used as the inorganic particulates, and resin particulates having an average particle diameter of approximately 20 nm to 500 nm are used as the resin particulates, and thus, an excellent air gap structure can be obtained.

In general, the average particle diameter of the pigment particle is approximately 40 nm to 110 nm, but in a case where a pigment ink for a light transmission filter using a pigment particle having a large particle size of 90 to 110 nm is used, it is preferable that the average pore diameter of the solvent absorption layer is set to 10 nm to 85 nm. According to this, more excellent and stable ink solvent absorptivity and solid-liquid separability can be obtained.

In a case of forming the average pore diameter in the range described above, inorganic particulates having a primary particle diameter of 10 nm to 85 nm and an aggregated secondary particle diameter of 50 nm to 400 nm, and resin particulates having an average particle diameter of 50 nm to 400 nm may be used.

In addition, in a case where a pigment ink for a light transmission filter containing a pigment particle having a small particle size of 40 nm to 50 nm is used, the average pore diameter of the solvent absorption layer 1601 is adjusted to 10 nm to 35 nm. According to this, more excellent and stable ink solvent absorptivity and pigment solid-liquid separability can be obtained, and higher optical transparency can be obtained. In addition, in a case of forming the average pore diameter in the range described above, preferably, inorganic particulates having a primary particle diameter of 10 nm to 35 nm and an aggregated secondary particle diameter of 50 nm to 200 nm, and resin particulates having an average particle diameter of 50 nm to 200 nm are used.

In addition, in a case of considering the absorption capacity of the solvent component and the conveying performance or the handling properties as the transfer material for a filter, it is preferable that the solvent absorption layer 1601 is formed to be thick. However, in the heating treatment where the pigment permeation layer is formed into a molten film, in a case where heat is transmitted to the solvent absorption layer 1601 through the solvent absorption layer 1601, it is advantageous that the solvent absorption layer 1601 is not thick. In the consideration of the inventors, in a case where the thickness of the solvent absorption layer 1601 is set to 20 μm to 300 μm, excellent ink solvent absorptivity, conveying performance, and handling properties can be obtained. In addition, the conveying performance and the handling properties of the transfer material 1 can be improved by using the substrate 50 together, and thus, even in a case where the thickness of the solvent absorption layer is set to 10 μm to 80 μm, excellent ink solvent absorptivity can be obtained. Here, in a case where the substrate 50 is thick, and a material having low heat conductivity is used, it is necessary to consider the heat conductivity in the solvent absorption layer 1601, and thus, it is preferable that the thickness of the solvent absorption layer 1601 is adjusted to 20 μm to 80 μm. Further, in a case of using the substrate 50 together, the thickness of the solvent absorption layer 1601 may be adjusted to 10 μm to 60 μm.

### (Air Gap Capacity and Porosity of Solvent Absorption)

According to the consideration of the inventors, the air gap capacity of the air gap absorption type solvent absorption layer 1601 configured of the inorganic particulates and the water-soluble resin is approximately 0.1 cm³/g to 3.0 cm³/g. In a case where the solvent absorption layer 1601 is thin, and pore volume is less than 0.1 cm³/g, sufficient ink absorptivity is not obtained, and there is a concern that the ink overflows, and the unabsorbed ink solvent remains in the pigment permeation layer 1600.

In addition, in a case where the solvent absorption layer 1601 is configured to be thick in a slightly large air gap structure, and the pore volume is greater than 3.0 cm³/g, the strength of the solvent absorption layer 1601 is weakened, and a crack or fall-off of a powder occurs in the solvent absorption layer 1601. In a case where the air gap absorption type solvent absorption layer 1601 configured of the inorganic particulates and the water-soluble resin has the air gap capacity described above, the porosity of the ink receiving layer is approximately 60% to 90%. In a case where the porosity of the solvent absorption layer 1601 is less than or equal to 60%, sufficient ink absorption capacity is not be obtained, and there is a case where the ink overflows, and the unabsorbed ink solvent remains in the pigment permeation layer 1600. In addition, in a case where the porosity is greater than 90%, there is a concern that the strength of the solvent absorption layer 1601 is weakened, and a crack or fall-off of powder occurs in the solvent absorption layer 1601.

### (Maintenance of Air Gap Structure)

In addition, an air gap between the inorganic particulates bound by the water-soluble resin is approximately evenly provided on the entire ink receiving layer, and thus, it is possible to allow the ink to approximately isotropically permeate. In addition, the inorganic particulates are bound by a binder of the water-soluble resin, and thus, in the ink receiving layer on which the air gap is provided, the inorganic particulates are an extremely hard material, and thus, the air gap structure is hardly broken even due to a pressure or heat, and the air gap structure can be nearly retained even after a heating and compressive bonding treatment. For this reason, the absorbed ink can be retained in the air gap structure, and even in a case where vapor is generated, the vapor can be sealed in the air gap structure. For this reason, a main solvent or a nonvolatile solvent such as water which is the liquid component of the pigment ink for a light transmission filter does not seep out on the front surface, and the pigment permeation layer 1600 can be properly formed into a molten film, and thus, the pigment retention film 1650 can be excellently adhesively transferred to the image support 55. That is, the solvent component of the pigment ink for a light transmission filter 1003 rarely reversely flows into the pigment permeation layer 1600 immediately after the ink jet printing of the pigment ink for a light transmission filter 1003. For this reason, it is not necessary to wait for the drying of the solvent absorbed in the solvent absorption layer 1601, and thus, it is possible to rapidly perform the pressurizing and heating treatment with respect to the image support 55. That is, an enormous amount of drying energy or time for drying the solvent component 1607 is not necessary, and thus, it is possible to efficiently form the pigment permeation layer 1600 into a molten film in a simple step.

### (Inorganic Particulates or Hardly Melted Resin Particulates)

The type of the inorganic material configuring the inorganic particulates is not particularly limited. In addition, the air gap absorption type ink receiving layer configured of the inorganic particulates and the water-soluble resin can be prepared without being subjected to a special orientation treatment, and thus, productivity is also excellent. Here, an inorganic material having high ink absorption performance is preferable. In the inorganic particulates formed of the inorganic material, alumina particulates, silica particulates, or the like formed of at least one type of substances selected from the group consisting of alumina and hydrated alumina are preferable.

Resin particulates which has a melting temperature Tg higher than a transfer temperature and are hardly melted and deformed even at the time of being adhesively transferred by the pressurizing and heating, are bound by a binder resin instead of the inorganic particulates, and thus, it is possible to form the air gap absorption type solvent absorption layer on which the air gap is formed. In the resin particulates, in a case where the air gap structure is formed by using the resin particulates having the melt temperature Tg higher than the transfer temperature, the particle structure is maintained even when heat is generated in the pressurizing and heating treatment, and an air gap of a resin particle does not collapse. In addition, resin particulates having a softening and melting temperature higher than an adhesive transfer temperature are a resin having a high Tg, and in general, there are many cases where a molecular structure configuring the resin particulates is rigid, and the resin particulates are comparatively hard particles. For this reason, the air gap hardly collapses due to a pressure.

The type of the resin material configuring the resin particulates is not particularly limited, but a resin material which has high affinity with respect to the solvent component of the pigment ink for a light transmission filter, and is capable of maintaining the air gap structure stable at a normal temperature is preferable. As such a resin, a resin such as an acrylic resin, a vinyl acetate resin, a vinyl chloride resin, an ethylene/vinyl acetate copolymerization resin, a polyamide resin, a polyester resin, a urethane-based resin, and a polyolefin resin, or a copolymer resin thereof is preferable.

### (Water-Soluble Resin)

The water-soluble resin is a resin which is sufficiently mixed with water, or a resin of which solubility with respect to water is greater than or equal to 1 (g/100 g), at 25° C. In addition, in a case where the water-soluble resin is used in the air gap absorption type ink receiving layer along with the inorganic particulates or the resin particulates, the water-soluble resin functions as a binder binding the inorganic particulates. Examples of the water-soluble resin are capable of including starch, gelatin, casein, and modified materials thereof; polyvinyl alcohol (completely saponified polyvinyl alcohol, partially saponified polyvinyl alcohol, low saponified polyvinyl alcohol, and the like), a poly(meth)acrylic acid, and copolymer resins thereof, and the like. In the water-soluble resin, polyvinyl alcohol, it is particularly preferable to use saponified polyvinyl alcohol obtained by hydrolyzing (saponifying) polyvinyl acetate as the binder of the first solvent absorption layer 1670. In particular, polyvinyl alcohol having a degree of saponification of 70 mol % to 100 mol % is preferable. The degree of saponification indicates a percentage of the amount of mole of a hydroxyl group with respect to the total amount of mole of an acetic acid group and the hydroxyl group of polyvinyl alcohol. It is preferable that the ink receiving layer is formed of a composition containing polyvinyl alcohol of which an average degree of polymerization is 2,000 to 5,000. One type of the water-soluble resin can be independently used, and two or more types thereof can be used by being mixed. “Two or more types of the water-soluble resins” include water-soluble resins having different properties such as the degree of saponification or the average degree of polymerization.

It is preferable that a poly(meth)acrylic acid or a copolymer resin thereof is used as the binder of the pigment permeation layer or the first solvent absorption layer. That is, in a case where the poly(meth)acrylic acid or the copolymer resin thereof is used in the pigment permeation layer 1600, the poly(meth)acrylic acid or the copolymer resin thereof is capable of being melted at the time of adhering to the image support 55, and of adhering to the image support 55. In addition, in a case where the copolymer resin is used in the first solvent absorption layer 1611, the binder is easily dissolved at the time of peeling off the second solvent absorption layer 1612 by using a solvent, and thus, the second solvent absorption layer 1612 can be easily peeled off.

### (Method of Forming Solvent Absorption Layer on Substrate)

In order to improve the productivity of the solvent absorption layer 1601, and to increase the handling properties such as the conveying performance at the time of using an ink jet printing apparatus or the peelability of the solvent absorption layer 1601 at the time of being adhesively transferred to the image support 55, the substrate 50 can be also used in the transfer material 1. In this case, it is not necessary to form the solvent absorption layer to be thick in order to improve the conveying performance or the handling properties, and thus, the thickness of the solvent absorption layer may be adjusted to be a sufficient film thickness for absorbing the solvent component, for example, approximately 10 μm to 80 μm.

The solvent absorption layer is formed by preparing a coating liquid by suitably mixing at least the inorganic particulates or the resin particulates and the water-soluble resin as a medium, by applying a coating liquid onto the front surface of the substrate with a known coater, and by drying the coating liquid. Accordingly, it is possible to form the solvent absorption layer having a desired air gap structure. A known method of the related art can be used as a coating method. Examples of the coating method are capable of including a blade coating method, an air knife coating method, a curtain coating method, a slot die coating method, a bar coating method, a gravure coating method, a roll coating method, and the like. For example, a surfactant, a pigment dispersant, a thickener, a defoamer, an ink fixative, an antioxidant, an ultraviolet absorber, a preservative, a pH regulator, and the like may be added to the coating liquid, as other additives, according to the application.

A particle concentration of the inorganic particulates or the resin particulates in the coating liquid may be suitably determined in consideration of coatability of the coating liquid, or the like, but is not particularly limited. Here, it is preferable that the particle concentration is greater than or equal to 10 wt % and less than or equal to 30 wt % with respect to the total weight of the coating liquid, from the viewpoint of a coating speed and film evenness. In addition, the amount of water-soluble resin is set to be 3.3 pts.wt. to 20 pts.wt., preferably greater than or equal to 3.3 pts.wt. and less than or equal to 20 pts.wt., and more preferably greater than or equal to 5 pts.wt. and less than or equal to 15 pts.wt., with respect to 100 pts.wt. of the inorganic particulates or the resin particulates, and thus, it is possible to form the air gap absorption type solvent absorption layer. By setting the particle concentration of the resin particulates to be in the range described above, the absorptivity of the ink can be excellent, and an air gap between the particulates bound by the water-soluble resin can be approximately evenly provided in the entire solvent absorption layer 1601. Accordingly, it is possible to allow the solvent component of the pigment ink for a light transmission filter to approximately isotropically permeate.

Furthermore, it is not preferable that the amount of water-soluble resin is less than or equal to 3.3 pts.wt., since the amount of binder for binding the inorganic particulates or the resin particulates decreases, and thus, there is a concern that the strength of the solvent absorption layer decreases, and fissuring and fall-off of powder occur. On the other hand, it is not preferable that the amount of water-soluble resin is greater than or equal to 20 pts.wt., since the amount of water-soluble resin increases, and thus, the air gap of the solvent absorption layer is buried with the water-soluble resin, and the absorptivity of the solvent component is degraded. It is preferable that a coating amount of the coating liquid is greater than or equal to 10 g/m² and less than or equal to 80 g/m², in terms of solid content. The coating amount is set to be greater than or equal to 10 g/m², and preferably greater than or equal to 15 g/m², and thus, it is possible to form the solvent absorption layer 1601 excellent for the absorptivity of the solvent component in the pigment ink for a light transmission filter. On the other hand, the coating amount is set to be less than or equal to 80 g/m², and more preferably less than or equal to 60 g/m², and thus, when the solvent absorption layer, which is a thick film, is dried, the curling hardly occurs.

### (Adhesion Layer)

In a filter manufacturing step, in a case where the transfer material 1 and the substrate 50 are used together, the adhesion layer 1603 can be disposed in advance on the substrate 50 by using a known coater, and the solvent absorption layer 1601 can be applied onto the adhesion layer 1603 (refer to FIG. 1C). The type of an adhesive primer configuring the adhesion layer 1603 is not particularly limited, and can be formed by using for example, a thermoplastic synthetic resin, a natural resin, rubber, wax, or the like as such a material. Furthermore, a surfactant may be added as necessary. The adhesion layer 1603 is formed on the substrate 50 by coating a composition containing an adhesive primer onto the substrate with a known coating device, and by drying the composition. The particle concentration of the coating liquid may be suitably determined in consideration of the coatability of the coating liquid or the like, and is not particularly limited, but it is preferable that the is greater than or equal to 0.1 wt % and less than or equal to 5 wt % with respect to the total weight of the coating liquid, from the viewpoint of the coating speed and the film evenness. It is preferable that the coating amount of the coating liquid is greater than or equal to 0.1 g/m² and less than or equal to 1 g/m² in terms of solid content. The coating amount is set to be greater than or equal to 0.1 g/m², and preferably less than or equal to 1 g/m², and thus, excellent adhesion between the solvent absorption layer 1601 and the substrate 50 can be maintained.

In addition, it is also effective that the front surface of the substrate 50 to be coated with the solvent absorption layer 1601 is subjected in advance to a surface modification treatment by performing a corona discharge treatment or a plasma discharge treatment, or is coated with an organic solvent such as IPA or acetone, and thus, the coatability of the front surface of the substrate 50 is improved, from the viewpoint of improving the adhesion between the substrate 50 and the solvent absorption layer 1601.

### (Pigment Permeation Layer)

The pigment permeation layer 1600 of the transfer material 1 for a filter is laminated on the solvent absorption layer 1601 by using a material which is capable of removing the air gap structure by being formed into a molten film by the pressurizing and heating treatment, such that a thin air gap structure having an air gap diameter which is sufficiently larger than the pigment particle is configured. That is, the pigment permeation layer 1600 is configured of the ink receiving layer of the air gap absorption type thin film which is capable of smoothly performing the permeation, and the diffusion and absorption of the solvent and pigment particle of the pigment ink for a light transmission filter applied by the ink jet printing apparatus.

### (Air Gap Diameter (Pore Diameter) of Pigment Permeation Layer)

The size of the resin particulates may be determined such that a desired air gap structure can be obtained, by considering the size of the pigment particle to be assumed in the ink jet printing apparatus such that the air gap of the pigment permeation layer, which is a thin film, is sufficiently larger than the pigment particle. According to the consideration of the inventors, it is preferable that the average of pore diameters (an average pore diameter) of the air gap absorption type pigment permeation layer configured of the inorganic particulates and the water-soluble resin is approximately 50 nm to 200 nm.

The size of the pigment particle, which is usually used, is approximately 40 nm to 110 nm, and thus, for example, in order to perform permeation and diffusion with respect to a large pigment particle of approximately 90 nm to 110 nm, an air gap structure of approximately 120 nm to 180 nm may be configured by using resin particulates of approximately 600 nm to 1.8 μm. In addition, in a case of assuming a high-image quality pigment ink for a light transmission filter using a pigment particle having a small particle size of approximately 40 nm to 50 nm, an air gap structure of approximately 60 nm to 180 nm may be configured by using resin particulates of approximately 300 nm to 1.8 μm.

According to the consideration of the inventors, in a case of considering the viewpoint of a film strength, an ink absorption speed, or the like in addition to the permeation of the pigment particle, it is preferable that the average of pore diameters (an average pore diameter) of the air gap absorption type pigment permeation layer 1600 configured of the resin particulates and the water-soluble resin is approximately 50 nm to 200 nm. In the pigment permeation layer of the air gap structure having an average pore diameter of less than or equal to 50 nm, most of the pigment particles of the pigment ink for a light transmission filter is not capable of permeating, but the pigment particles remain on the front surface of the pigment permeation layer 1600. For this reason, when the pigment permeation layer 1600 is formed into a molten film, and is adhesively transferred to the image support 55, there is a concern that the pigment particle having weak adhesion is interposed between the image support 55 and the pigment retention film 1650, and the adhesive transfer properties decrease. On the other hand, in a case where the average pore diameter is greater than or equal to 200 nm, the film strength of the pigment permeation layer is weakened, and thus, there is a concern that a crack or fall-off of powder easily occurs at the time of being conveyed in the ink jet printing apparatus.

### (Film Thickness of Pigment Permeation Layer)

In a case where the pigment permeation layer 1600 does not have permeation anisotropy, the pigment ink for a light transmission filter isotropically permeates and is isotropically diffused not only in the film thickness direction but also in the planar direction. Accordingly, in order to prevent bleeding of an image by suppressing spreading of an ink in the planar direction, it is desirable that the permeation of the entire pigment permeation layer is controlled, and the film thickness of the pigment permeation layer is adjusted according to a desired ink absorption amount. In a case where the thickness of the pigment permeation layer is set to 1 μm to 10 μm, excellent pigment permeation and pigment diffusibility are exhibited. In addition, in the transfer material 1 of this embodiment, it is necessary that the pigment ink for a light transmission filter landed on the front surface of the pigment permeation layer 1600 sequentially permeates in the pigment permeation layer 1600, and the tip end of the pigment ink for a light transmission filter rapidly reaches the interface with respect to the solvent absorption layer 1601. For this reason, in a case where the film thickness of the pigment permeation layer 1600 is excessively thick, there is a concern that approximately all of the pigment inks for a light transmission filter solvent component are not capable of being absorbed in the solvent absorption layer, and a decrease in the adhesive transfer properties is concerned.

Further, in a case where the film thickness of the pigment permeation layer 1600 is thicker than the size of the ink droplet of the pigment ink for a light transmission filter, the pigment ink for a light transmission filter does not reach the interface with respect to the solvent absorption layer 1601, but the solvent component and the pigment particle are absorbed in the pigment permeation layer. In this case, the solid-liquid separation of the pigment ink for a light transmission filter is not capable of being performed in addition to a decrease in the adhesive transfer properties, and thus, there is a concern that it is not possible to form a pigment film which is thinly and densely compressed on the bottom of the pigment permeation layer 1600. That is, it is preferable that the pigment permeation layer 1600 is configured into a thin film such that the tip end of the landed pigment ink for a light transmission filter can be rapidly in contact with the interface with respect to the solvent absorption layer 1601.

In addition, the air gap of the pigment permeation layer 1600 is sufficiently larger than the pigment particle, and thus, the capillary force of the air gap is also weakened. For this reason, time until the pigment ink for a light transmission filter reaches the interface between the pigment permeation layer 1600 and the solvent absorption layer easily lengthens, and thus, it is not preferable that the pigment permeation layer is configured to have a film thickness of greater than 10 μm. On the other hand, in a case where the pigment permeation layer 1600 is less than 1 μm, all of the printed pigment particles are not stored in the pigment permeation layer 1600, but overflows into the front surface in a case of performing printing with a high concentration, and thus, a decrease in scratch properties of the pigment film 1606 is concerned. For this reason, in a case of forming the pigment film 1606 having a high concentration with high resolution, it is more preferable that the thickness of the pigment permeation layer 1600 is adjusted to 2 μm to 5 μm.

(Formation of Pigment Permeation Layer into Molten Film)

In addition, in the pressurizing and heating treatment, the resin particle and the bonding resin configuring the pigment permeation layer are formed into a molten film while enclosing the pigment particle 1003a, and adhere to the image support 55, and thus, the transfer material 1 is capable of forming the rigid pigment retention film 1650 on the front surface of the image support 55. For this reason, the pigment permeation layer 1600 is formed of large resin particulates which are a resin material having a melting temperature Tg of lower than the transfer temperature and, and are bound by the binder resin to form an air gap structure which is sufficiently larger than the pigment particle 1003a, such that the pigment permeation layer 1600 can be formed into a molten film at the time of being adhesively transferred by the pressurizing and heating treatment. In order to form the air gap structure which is sufficiently larger than the pigment particle 1003a, large resin particulates of the same degree of a visible light wavelength are used in the pigment permeation layer 1600. Accordingly, innumerable recesses and protrusions in a state where the resin particulates are peeled off, exist in the front surface or the air gap structure of the pigment permeation layer 1600 before being formed into a molten film. For this reason, in a case where the pigment permeation layer 1600 is not completely formed into a molten film, and the air gap structure remains, there is a concern that visible light scatters on the front surface or the air gap of the resin particulates, and light absorption and transmittance of the color filter decreases. In order to solve such a problem, it is preferable that the pigment permeation layer 1600 is formed into a molten film while the air gap structure of the pigment permeation layer 1600 itself is completely removed, and recesses and protrusions generated on an adhesive surface with respect to the image support are completely buried, at the time of being adhesively transferred to the image support 55 by the pressurizing and heating treatment.

### (Melting Temperature of Pigment Permeation Layer)

The pigment permeation layer 1600 of this embodiment, which can be formed into a molten film, are configured of resin particulates which form a particle state for configuring an air gap before being subjected to the pressurizing and heating treatment, and are formed into a molten film after being subjected to the pressurizing and heating treatment, and a water-soluble resin allowing the resin particulates to adhere to each other. It is preferable that a resin material having excellent adhesion with respect to the front surface of the pigment particle 1003a or the image support 55 is used for at least one of the resin particulates and the water-soluble resin. The resin particulates are capable of easily controlling the particle state or the film state by a molten film formation temperature Tg. The molten film formation temperature Tg may be in a range which is higher than the drying temperature at the time of manufacturing the ink jet transfer material and is lower than the heating temperature at the time of performing heating and compressive bonding.

According to the consideration of the inventors, a preferred molten film formation temperature Tg is approximately 30° C. to 120° C. In a case where a molten film formation temperature Tg is lower than or equal to 30° C., there is a case where the pigment permeation layer 1600 is formed into a molten film without being pressurized in a case of being stored at a room temperature. In contrast, in a case where the molten film formation temperature Tg is higher than or equal to 120° C., the pressurizing and heating are performed from the substrate side, and a temperature for forming the pigment permeation layer 1600 into a molten film increases, and thus, an excessive amount of heat is required, and there is a case where a heating efficiency decreases.

### (Material Example of Pigment Permeation Layer)

The pigment permeation layer 1600 is configured of the resin particulates which form a particle state for configuring an air gap before being subjected to the pressurizing and heating and are formed into a molten film after being subjected to the pressurizing and heating, and a water-soluble resin, which is a binder of the resin particle. It is preferable to use an acrylic resin, a urethane-based resin, a vinyl acetate resin, a vinyl chloride resin, an ethylene/vinyl acetate copolymerization resin, and the like, as the material of the resin particle which is formed into a film to enclose the pigment particle 1003a and forms the rigid pigment retention film 1650. A molten film formation temperature Tg of the resin particulates may be in a range which is higher than the drying temperature at the time of manufacturing the transfer material 1 and is lower than the heating temperature at the time of performing the heating and compressive bonding treatment (the molten film formation temperature Tg is approximately 30° C. to 120° C.), and the drying temperature is controlled, and thus, the pigment permeation layer 1600 which can be formed into a molten film, is manufactured.

It is preferable that the water-soluble resin as resin particulates or a bonding material used in the pigment permeation layer 1600, is configured of a material having low affinity with respect to the water-soluble resin as the bonding material used in the solvent absorption layer 1601, which is a layer to be removed after being adhesively transferred. The affinity between the resin material of the pigment permeation layer 1600 and the resin material of the solvent absorption layer 1601 decreases, and thus, even in a case where both of the resin materials are melted at the time of being subjected to the pressurizing and heating treatment, the resin materials hardly adhere to each other. For this reason, the solvent absorption layer 1601 can be easily peeled off from the interface with respect to the pigment permeation layer 1600.

### (Material Example of Second Pigment Permeation Layer)

As illustrated in FIG. 1C, in the transfer material including the first pigment permeation layer 1670 and the second pigment permeation layer 1680, it is preferable that the second pigment permeation layer 1680 is configured of the following materials. As with the first pigment permeation layer 1670, the second pigment permeation layer 1680 is configured of resin particulates which form a particle state for configuring an air gap before being subjected to the pressurizing and heating treatment and are formed into a molten film after being subjected to the pressurizing and heating treatment, and a water-soluble resin, which is a binder of the resin particulates. In addition, it is preferable that the second pigment permeation layer 1680 is configured of a resin material having excellent adhesion with respect to the image support 55 such as glass. Furthermore, a material having a particle diameter which is slightly larger than that of the resin particle configuring the first pigment permeation layer 1670, is used for the resin particle used in the second pigment permeation layer 1680, such that an air gap structure which is sufficiently larger than the pigment particle and is slightly larger than the pore of the first pigment permeation layer can be configured. Accordingly, it is possible to obtain the second pigment permeation layer 1680 which has an air gap structure having excellent permeation of the pigment particle and has excellent adhesion with respect to the image support 55 at the time of being melted. An acrylic resin, a urethane-based resin, and the like are preferable as the material of the resin particle used in the second pigment permeation layer 1680. A thin film having a film thickness of approximately 1 μm to 3 μm may be required, and volume only for enabling an even adhesive reinforcement film to be formed by burying the recesses and protrusions, or the air gap over the entire surface between the image support and the pigment retention film at the time of being formed into a molten film may be required.

(Film Production Method of Pigment Permeation Layer with Respect to Solvent Absorption Layer)

In a case of forming the pigment permeation layer on the solvent absorption layer 1601 having an air gap, the front surface of the solvent absorption layer 1601 may be treated in advance with dampening water, soaking water, or the like, and the air gap of the solvent absorption layer 1601 may be filled with a liquid, and then, a coating liquid for a pigment permeation layer 1600 may be applied. In the pigment permeation layer, at least the resin particulates and the water-soluble resin are mixed with a suitable medium, and thus, the coating liquid is prepared, and the coating liquid is applied onto the front surface of the solvent absorption layer 1601, and is dried, and thus, the air gap structure can be formed. Here, in a case where the coating liquid for forming the pigment permeation layer 1600 is applied onto the front surface of the solvent absorption layer 1601, the water-soluble resin also permeates in the air gap of the solvent absorption layer 1601 along with the moisture of the coating liquid of the pigment permeation layer 1600, and thus, there is a case where the air gap of the solvent absorption layer 1601 is buried. In addition, in the pigment permeation layer 1600, the resin particle larger than the air gap of the solvent absorption layer 1601 are used, but there is a case where the resin particulates having a particle size smaller than the air gap are contained in the coating liquid, such as a case where a particle size distribution is not sharp and particulate cutting is insufficient. In this case, there is a concern that the air gap of the solvent absorption layer 1601 is buried.

In the solvent absorption layer of the transfer material of this embodiment, it is necessary to maintain a high ink absorption speed such that approximately the total amount of the moisture or the solvent component 1607 in the ink can be rapidly absorbed in the solvent absorption layer. For this reason, it is important to maintain the air gap in the solvent absorption layer 1601. In addition, the moisture of the coating liquid of the pigment permeation layer 1600 rapidly permeates in the air gap of the solvent absorption layer 1601, and thus, there is a case where air bubbles are generated in a process of being replaced with the air remaining in the air gap of the solvent absorption layer 1601. When the air bubbles are discharged through the coating liquid of the pigment permeation layer 1600, the air bubbles are trapped in the coating liquid of the pigment permeation layer 1600, and there is a case where a coating defect that the air bubbles remain on a coating surface occurs.

In order to avoid such a coating defect, the front surface of the solvent absorption layer 1601 may be treated in advance with dampening water, soaking water, or the like, and the air gap of the solvent absorption layer 1601 may be filled with the liquid, and then, the coating liquid for forming the pigment permeation layer 1600 may be applied. The air gap of the solvent absorption layer 1601 is buried with the dampening water or the soaking water, and thus, it is possible to discharge the air existing in the air gap of the solvent absorption layer 1601 to the outside before the coating liquid for forming the pigment permeation layer 1600 is applied. Further, in the coating of the coating liquid for forming the pigment permeation layer, it is possible to prevent the water-soluble resin or the fine resin particulates from entering the air gap.

Furthermore, as with the solvent absorption layer 1601, a particle concentration of the resin particulates in the coating liquid may be suitably determined in consideration of the coatability of the coating liquid, or the like, but is not particularly limited. Here, it is preferable that the particle concentration is greater than or equal to 10 wt % and less than or equal to 30 wt % with respect to the total weight of the coating liquid, from the viewpoint of a coating speed and film evenness. It is preferable that a coating amount of the coating liquid is greater than or equal to 1 g/m² and less than or equal to 10 g/m² in terms of solid content. The coating amount is set to be greater than or equal to 1 g/m², and preferably less than or equal to 10 g/m², and thus, it is possible to exhibit excellent pigment permeation and pigment diffusibility.

In addition, the same method as that of the solvent absorption layer 1601 can be used as a coating method. Furthermore, in order to form the pigment permeation layer 1600 which can be formed into a molten film, it is necessary to strictly control a drying temperature after the coating liquid of the pigment permeation layer 1600 is applied. The resin particulates forming the pigment permeation layer 1600 are subjected to the pressurizing and heating treatment at the time of being adhesively transferred to the image support 55, and thus, a material which is formed into a molten film is selected. For this reason, in a manufacturing step of the transfer material, it is necessary to set the drying temperature at the time of forming the pigment permeation layer 1600 to be lower than the molten film formation temperature Tg of the resin particulates such that the resin particulates maintain the particle state and form the air gap structure. In the formation of the pigment permeation layer 1600, in a case where the pigment permeation layer 1600 is heated and dried at a temperature higher than or equal to a temperature at which the resin particulates are formed into a molten film, for a long period of time, the resin particulates are melted and softened, and the air gap structure is not capable of being maintained, and thus, an extreme caution is required for a drying condition. On the other hand, in a case where the drying temperature at the time of forming the pigment permeation layer 1600 is high, it is possible to increase the coating speed. Accordingly, it is preferable that the drying temperature at the time of forming the pigment permeation layer 1600 is as high as possible, from the viewpoint of productivity.

### (First Solvent Absorption Layer)

As illustrated in FIG. 1D and FIG. 1E, the transfer material 1 may be configured of a plurality of layers (in the drawing, the first solvent absorption layer 1611 and the second solvent absorption layer 1612). In this case, it is necessary for the first solvent absorption layer 1611 to form the air gap which is sufficiently smaller than the pigment particle by bonding the resin particulates which can be melted and deformed by the pressurizing and heating treatment, with the binder resin. In addition, in the pressurizing treatment when the transfer material 1 is adhesively transferred to the image support 55, it is preferable that the air gap structure is removed, and the transfer material 1 is formed into a molten film. The first solvent absorption layer 1611 is disposed on the front surface of the second solvent absorption layer 1612 before the pigment permeation layer 1600 is applied.

### <Material Example of First Solvent Absorption Layer>

The first solvent absorption layer 1611 is configured by being laminated on the second solvent absorption layer 1612 by using the resin particulates which are the same material as that of the pigment permeation layer and has a significantly small particle diameter, as with the pigment permeation layer 1600. The resin particulates of the first solvent absorption layer 1611 has a particle diameter approximately smaller than or equal to the pigment particle, and has a particle diameter which is slightly larger than that of the inorganic particulates configuring the second solvent absorption layer 1612. Thus, the particle diameter of the resin particulates of the first solvent absorption layer 1611 is selected, and thus, it is possible to configure an air gap structure having an air gap which is smaller than the pigment particle and is slightly larger than the air gap of the second solvent absorption layer 1612. Accordingly, the first solvent absorption layer 1611 is capable of separating the pigment particle from the solvent component on the interface with respect to the pigment permeation layer 1600, and of rapidly absorbing the solvent component. It is important for the first solvent absorption layer 1611 to rapidly move the absorbed solvent component to the second solvent absorption layer 1612 side. For this reason, the first solvent absorption layer 1611 is configured to be a film thinner than the second solvent absorption layer 1612. In addition, the solvent component absorbed in the first solvent absorption layer 1611 is mostly absorbed in the second solvent absorption layer 1612, and thus, hardly remains in the first solvent absorption layer 1611. For this reason, the solvent component can be formed into a molten film by the pressurizing and heating, even immediately after the ink jet printing. That is, the second solvent absorption layer 1612 has a high capillary force, and has absorption capacity of a mass of solvent due to a sufficient film thickness, and thus, approximately all of the solvent components rapidly pass through the first solvent absorption layer 1611, which is a thin film, and are absorbed in the second solvent absorption layer 1612, which is a thick film.

In addition, the first solvent absorption layer 1611 is configured of the same resin material as that of the pigment permeation layer 1600, and thus, the first solvent absorption layer 1611 is melted to be a film as with the pigment permeation layer 1600, according to the pressurizing and heating treatment for adhesively transferring the transfer material 1 to the image support 55. Accordingly, the first solvent absorption layer 1611 forms a transparent protective film protecting the pigment particle.

In a case of disposing the first solvent absorption layer 1611 which can be formed into a molten film, the first solvent absorption layer 1611 is configured of resin particulates which form a particle state before being subjected to the pressurizing and heating treatment and are formed into a molten film after being subjected to the pressurizing and heating treatment, and a water-soluble resin which is a binder of a resin particle. Here, the first solvent absorption layer 1611 configures an air gap which is sufficiently smaller than the pigment particle such that the pigment particle can be subjected to the solid-liquid separation, and thus, the resin particulates having a particle size smaller than that of the resin particulates which are used in the pigment permeation layer 1600 and can be formed into a molten film are used. As such a resin, it is possible to use a resin such as an acrylic resin, a vinyl acetate resin, a vinyl chloride resin, an ethylene/vinyl acetate copolymerization resin, a polyamide resin, a polyester resin, a urethane-based resin, and a polyolefin resin, or copolymer resins thereof. A molten film formation temperature Tg of the resin particulates may be in a range of higher than the drying temperature at the time of manufacturing the ink jet transfer material and lower than the heating temperature at the time of performing the heating and compressive bonding (the molten film formation temperature Tg is approximately 30° C. to 120° C.), and the drying temperature is controlled, and thus, the first solvent absorption layer 1611 can be formed into a molten film is manufactured.

### (Adhesion Layer Disposed on Interface Between First Solvent Absorption Layer and Pigment Permeation Layer)

As described above, in a case where the first solvent absorption layer 1611 is formed into a molten film, and remains on the front surface of the pigment permeation layer 1600 as a protective film, as with the example illustrated in FIG. 1C, an adhesion layer may be disposed between the first solvent absorption layer 1611 and the pigment permeation layer 1600. It is preferable that a material having high mutual affinity is selected as the water-soluble resin configuring the first solvent absorption layer 1611 and the pigment permeation layer 1600. For example, such a material can be formed by using a thermoplastic synthetic resin, a natural resin, rubber, wax, and the like. Furthermore, in a case where the adhesion layer is added onto the interface between the first pigment permeation layer 1670 and the pigment permeation layer 1600, the thickness may be very thin such that continuousness of each ink absorption is not impaired. In particular, in a case where the material configuring the adhesion layer has water repellency, the material may be configured to be approximately smaller than or equal to the air gap diameter of the first solvent absorption layer 1611. Further, in a case where the adhesion layer is coated with a coating liquid of a particle-shaped adhesive primer, the front surface of the first solvent absorption layer 1611 may be treated in advance with dampening water, soaking water, or the like such that a fine adhesive primer particle does not enter the air gap of the first solvent absorption layer 1611, and the air gap of the first solvent absorption layer 1611 may be filled with a liquid, and then, an adhesive primer may be applied.

### (Release Layer)

In the transfer material 1, a release layer, which is a very thin film, can also be disposed between the solvent absorption layer 1601 and the pigment permeation layer 1600 or between the first solvent absorption layer 1611 and the second solvent absorption layer 1612. According to this, the transfer material 1 is adhesively transferred to the image support 55, and then, the solvent absorption layer 1601 can be properly removed. For example, as with the transfer material 1C illustrated in FIG. 1C, the release layer 1701 can also be disposed on the interface between the solvent absorption layer 1601 and the pigment permeation layer 1600. In the transfer material 1C, the second pigment permeation layer 1680 is transferred to the image support 55, and the rigid pigment retention film 1650 is formed, and then, the solvent absorption layer 1601 can be easily removed through the release layer 1701. According to this, an optical influence of the solvent absorption layer 1601, which is a thick film, on an image is not generated at all. Accordingly, the solvent absorption layer 1601 can be manufactured in consideration of only ink absorptivity such as ink absorption capacity, without considering optical properties, flexibility, foil cutting capability, and the like, and a degree of freedom of the design of the solvent absorption layer 1601 can be considerably improved.

In addition, the release layer may be configured of a very thin film-like layer having an even thickness, and may be provided as a layer on which the release agent is discretely provided. Specifically, the release layer may be disposed in the shape of sea-and-island, or may be patchily disposed. In a case of the release layer on which the release agent is discretely provided, a part of the absorbed ink can be rapidly in contact with an exposed lower layer even in a case where the release agent has ink repellency, and thus, it is possible to make excellent peelability and ink absorptivity compatible without impairing the continuousness of the ink absorption.

### <Material and Forming Method of Release Layer>

Examples of the material of the release agent for forming the release layer as described above include silicone wax represented by waxes such as silicone wax, a silicone-based material such as a silicone resin, a fluorine-based material such as a fluorine resin, a polyethylene resin, and the like. The peel-off layer can be formed by a roll coating method, a rod bar coating method, a spray coating method, an air knife coating method, a slot die coating method, or the like. By using such a method, a composition having the peelability described above is applied onto the solvent absorption layer 1601, and is dried, and thus, the release layer can be formed.

In the transfer material illustrated in FIG. 1C, the release layer 1701 is interposed between the front surface of the water-soluble resin forming the air gap structure by bonding front surfaces of the particulates configuring the solvent absorption layer 1601 or the particulates, and front surfaces of the resin particulates forming the pigment permeation layer 1600 or the front surface of the water-soluble resin forming the air gap structure, on the interface between the solvent absorption layer 1601 and the pigment permeation layer 1600. Accordingly, the release layer 1701 is formed into the shape of a very thin film such that the air gap structure formed on each layer in contact with the release layer 1701 is not impaired. The type of the release agent used in the release layer 1701 is not particularly limited, but preferably, is a material which has excellent releasability and is not easily melted by heat generated by heat of the heat roller 21 (FIG. 6).

In addition, a material which hardly adhere to the resin particulates or the water-soluble resin as the bonding material, used in a layer side transferred onto the image support, is preferable as the release material. According to the pressurizing and heating treatment, even in a case where the water-soluble resin, which is the bonding material of the solvent absorption layer 1601, is heated and melted, when affinity between the resin material used in the pigment permeation layer 1600, and the release agent used in the release layer 1701 is low, and thus, mutual adhesion hardly occurs, and peeling off is easily performed on the interface. Furthermore, in general, in a case where the release agent has a release function, simultaneously, the release agent has water repellency. For this reason, in a case where the release layer 1701 is added onto the interface between the solvent absorption layer 1601 and the pigment permeation layer 1600, it is necessary to form the thickness of the release layer 1701 to be very thin such that ink absorption properties due to the capillary force of the solvent absorption layer 1601 are not impaired.

In general, the average particle diameter of the pigment particle is approximately 40 nm to 110 nm, and thus, the average pore diameter of the solvent absorption layer 1601 is smaller than the average particle diameter of the pigment particle, and is adjusted to 5 nm to 100 nm. The thickness of the release layer 1701 may be approximately thinner than or equal to the air gap diameter of the solvent absorption layer 1601. That is, in a case where the thickness of the release layer 1701, which is a very thin film, disposed on the interface with respect to a small air gap structure of the solvent absorption layer 1601 is smaller than the air gap diameter, the solvent component is also capable of passing through the release layer 1701, which is a very thin film. That is, the pigment ink for a light transmission filter which has smoothly permeated in the pigment permeation layer 1600 has an inertial force, and thus, the solvent component of the pigment ink for a light transmission filter which is applied prior to the pigment ink for a light transmission filter is extruded. For this reason, even in a case where the release layer 1701 has water repellency, when the release layer 1701 is a very thin layer having a thickness of approximately 50 nm to 200 nm, the solvent component of the pigment ink for a light transmission filter passes through the release layer 1701. Further, the solvent component which has passed through the release layer 1701 reaches the air gap structure of the solvent absorption layer 1601 having a high capillary force, which is formed by using a hydrophilic material, and thus, rapidly absorbed.

As described above, even in a case where a release layer having low hydrophilicity is configured on the interface between the pigment permeation layer 1600 and the solvent absorption layer 1601, when the release layer is a film which is thinner than the air gap diameter of the solvent absorption layer 1601, the solvent component of the pigment ink for a light transmission filter is capable of passing through the release layer due to the inertial force of the pigment ink for a light transmission filter which has permeated in the pigment permeation layer 1600. For this reason, the release layer 1701 does not impair continuous absorption of the solvent component in the solvent absorption layer 1601.

In addition, as with a transfer material 1E illustrated in FIG. 1E, even in a case where the release layer 1701 is disposed on the interface between the first solvent absorption layer 1611 and the second solvent absorption layer 1612, the release layer 1701 which is thinner than the air gap diameter of the second solvent absorption layer 1612 is formed, and thus, it is possible to realize continuous absorption of the solvent component.

In another method of improving releasability, a solvent having releasability or the like is applied onto the front surfaces of the particulates or the bonding material on the interface with respect to the solvent absorption layer, into the shape of a very thin film, or a surface modification treatment is performed, and thus, it is also possible to improve releasability on the interface with respect to the solvent absorption layer without individually disposing the release layer. In this case, it is necessary to prevent a decrease in hydrophilicity due to the pollution of an inner surface of the air gap structure in the solvent absorption layer with the permeation, the vapor, or the like of the release agent.

### <Method of Forming Release Layer on Solvent Absorption Layer>

The release layer 1701 of this embodiment can be formed by applying a composition having peelability according to a roll coating method, a rod bar coating method, a spray coating method, an air knife coating method, a slot die coating method, or the like, and by drying the composition.

The concentration of the release layer 1701 in the coating liquid may be suitably determined in consideration of the coatability of the coating liquid or the like, and is not particularly limited, but it is preferable that the concentration is greater than or equal to 0.1 wt % and less than or equal to 5 wt % with respect to the total weight of the coating liquid, from the viewpoint of a coating speed and film evenness. It is preferable that a coating amount of the coating liquid is greater than or equal to 0.1 g/m² and less than or equal to 1 g/m² in terms of solid content. The coating amount is set to be greater than or equal to 0.1 g/m², and preferably less than or equal to 1 g/m², and thus, it is possible to maintain excellent peelability between the substrate 50 and the solvent absorption layer 1601, or the first solvent absorption layer 1611 which forms the protective layer and is formed into a molten film. In a case where the release agent having water repellency is applied, the front surface of the solvent absorption layer 1601 may be treated in advance with dampening water, soaking water, or the like, and the air gap of the solvent absorption layer 1601 may be filled with a liquid, and then, the coating liquid of the release agent may be applied. The air gap of the solvent absorption layer 1601 is buried with the dampening water or the soaking water, and thus, it is possible to discharge the air existing in the air gap of the solvent absorption layer 1601 to the outside before the coating liquid of the release agent is applied. Further, it is possible to prevent the release agent from entering the air gap of the solvent absorption layer 1601, and thus, to prevent a decrease in a capillary force. In addition, the release agent may be transferred to the solvent absorption layer 1601 as a very thin film according to a printing method such as a gravure method.

In addition, peelability may be improved by performing surface modification with respect to the substrate 50, without disposing a special release layer. Surface modification may be performed in which the front surface of the substrate 50 is inactivated. A method of the surface modification is not particularly limited, but for example, a vapor deposition method of a metal such as aluminum, zinc, and copper, a fluorine resin or a silicone resin, or the like, on the front surface of the substrate 50, or the like can be used. In such a front surface treatment, peelability between the substrate 50 and the solvent absorption layer 1601 increases, and the solvent absorption layer 1601 can be easily peeled off from the substrate 50 after being adhesively transferred to the image support 55.

### (Soluble Peelability of Solvent Absorption Layer)

In the transfer material 1 of this embodiment, the solvent absorption layer 1601 can also be easily peeled off by using a solvent. For example, a binder of the solvent absorption layer 1601 illustrated in FIG. 1B or the second solvent absorption layer 1612 illustrated in FIG. 1D is configured of polyvinyl alcohol, and the pigment permeation layer 1600 or the first solvent absorption layer 1611 is configured of a poly(meth)acrylic acid or a copolymer resin thereof. Then, the pigment permeation layer 1600 and the first solvent absorption layer 1611 are formed into a molten film and are adhesively transferred to the image support 55, and then, a solvent such as dimethylsulfoxide is absorbed and permeates in the air gap structure of the solvent absorption layer 1601 or the second solvent absorption layer 1612. Accordingly, the binder of the solvent absorption layer 1601 or the second solvent absorption layer 1612 can be dissolved, and the solvent absorption layer 1601 or the second solvent absorption layer 1612 can be peeled off. That is, dimethylsulfoxide as the dissolution liquid of the solvent absorption layer is absorbed and permeates in the solvent absorption layer 1601 or the second solvent absorption layer 1612 maintaining the air gap structure even after the heating and compressive bonding is performed, and thus, a PVA resin bonding the inorganic particulates of the solvent absorption layer 1601 can be broken by being dissolved. The solvent absorption layer 1601 or the second solvent absorption layer 1612 of which the bonding of the PVA resin is broken, can be easily scraped by a blade or the like, and after that, the front surface is washed with water, and thus, it is possible to properly remove the solvent absorption layer 1601 or the second solvent absorption layer 1612. At this time, the pigment permeation layer 1600 or the first solvent absorption layer 1611 is formed into a molten film, and the air gap structure does not exist, and thus, dimethylsulfoxide is not capable of permeating. In addition, an acrylic resin configuring the pigment permeation layer 1600 and the first solvent absorption layer 1611 is not dissolved in dimethylsulfoxide, and thus, the pigment permeation layer 1600 maintains the state of the pigment protective film 1650, and the first solvent absorption layer 1611 maintains the state of the protective film 1660. Accordingly, it is possible to transfer the pigment retention film 1650 to the image support 55 in an adequate state.

### (Material Example of Adhesive Agent)

The material of the adhesive agent or the enhanced adhesive layer may be selected according to various image supports 55 or applications. One type or a plurality of types of adhesive agents may be selected. For example, an enhanced adhesive layer may be used in which an adhesive agent having excellent adhesion with respect to a specific image support 55, and an adhesive agent having excellent adhesion with respect to the pigment permeation layer 1600 may be selected and mixed. Accordingly, the enhanced adhesive layer is capable of excellently adhering to either the image support 55 or the pigment retention film. For example, an adhesive agent using resin particulates formed of a polyurethane-based adhesive agent, an acrylic adhesive agent, or a material in which the adhesive agents are mixed is preferable as an adhesive agent having excellent adhesion with respect to a plastic image support 55, such as PET, PVC, PET-G, acryl, polycarbonate, POM, ABS, PE, and PP. In addition, adhesive agent using resin particulates formed of a polyurethane-based adhesive agent, an olefin-based adhesive agent, or a material in which the adhesive agents are mixed is preferable as an adhesive agent having excellent adhesion with respect to the image support 55 such as glass or a metal.

### (Method of Forming Adhesive Layer on Pigment Permeation Layer)

In the transfer material 1 of this embodiment, in order to reinforce the adhesion with respect to the image support, a coating liquid containing the adhesive agent can be applied onto the front surface of the pigment permeation layer 1600. At this time, the adhesive agent is patchily and discretely provided on the front surface of the pigment permeation layer 1600, and is applied such that an exposed portion where the front surface of the pigment permeation layer 1600 is directly exposed remains. The concentration of the adhesive agent in the coating liquid may be suitably determined in consideration of the coatability of the coating liquid, or the like, but is not particularly limited. The concentration of the adhesive agent in the coating liquid may be suitably determined in consideration of the coatability of the coating liquid, or the like. Here, it is preferable that the concentration is greater than or equal to 2 wt % and less than or equal to 40 wt % with respect to the total weight of the coating liquid, from the viewpoint of a coating speed and evenness of the adhesive agent.

It is necessary to discretely provide the adhesive agent on the front surface of the air gap absorption type pigment permeation layer 1600, and thus, it is preferable to use a gravure coating method as a coating method. In this case, the number of groove lines of a gravure roll may be preferably approximately 200 lines, and may be more preferably approximately 300 lines. In a case where the number of groove lines of the gravure roll is greater than 600 lines, an interval between the adjacent adhesive agents becomes excessively narrow, and the ink droplet of the pigment ink for a light transmission filter 1003 easily straddles between the adjacent adhesive agents, and thus, there is a case where time required for the ink droplet to reach the front surface of the pigment permeation layer 1600 becomes longer.

In addition, in a case where a coating liquid of the particle-shaped adhesive agent is applied onto the front surface of the pigment permeation layer 1600 formed on the substrate 50, a caution is required such that an adhesive agent particle does not enter the air gap of the pigment permeation layer 1600. A particle which is larger than the air gap of the pigment permeation layer 1600 is used in the adhesive agent particle, but in a case where the adhesive agent particle is a secondary aggregate, or a particle size distribution is not sharp and particulate cutting is not sufficient, there is a case where an adhesive agent having a particle size smaller than the air gap is contained in the coating liquid. In the pigment permeation layer 1600 of the transfer material 1 of this embodiment, it is important to maintain the air gap structure such that most of the pigment ink for a light transmission filter 1003 can be rapidly absorbed in a front surface of the adhesive agent without remaining. For this reason, it is preferable that the air gap structure of the pigment permeation layer 1600 and the solvent absorption layer 1601 is treated in advance with soaking water or the like before the coating liquid of the adhesive agent is applied, and the air gap of the pigment permeation layer 1600 and the solvent absorption layer 1601 is filled with a liquid, and then, a coating liquid of a protective film reinforcing agent is applied. Accordingly, it is possible to prevent a fine adhesive agent particle from entering the air gap of the pigment permeation layer 1600.

In addition, the adhesive agent is configured of a material which is softened and is formed into a molten film in a case of being heated by the heating and compressive bonding treatment, and thus, sufficient consideration is required at a temperature in a drying step after the adhesive agent is applied. That is, it is preferable that the drying step is performed at a temperature lower than a film formation temperature or a glass transition temperature at which the adhesive agent is softened and melted. Here, in a case where the exposed portion of the pigment permeation layer 1600 is capable of maintaining the air gap structure in which the pigment ink for a light transmission filter 1003 is capable of being absorbed and of permeating, in the drying step, a temperature or time for the drying step may be adjusted such that the front surface of the adhesive agent is slightly melted and softened, and adheres to the pigment permeation layer 1600. In the setting of the drying time, the temperature at which the adhesive agent is softened and formed into a molten film may be measured in advance, and adequate drying time may be set on the basis of the measured temperature. That is, it is preferable to set the drying temperature or the drying time where the air gap structure of the pigment permeation layer 1600 is maintained, and the area of the adhesive agent which is directly in contact with the pigment permeation layer 1600 increases, and thus, it is possible to suppress a decrease in the exposed portion of the front surface of the pigment permeation layer 1600, and to obtain excellent productivity.

In addition, a plurality of types of particles may be contained in the adhesive agent, and one particle may have a function as a binder of the adhesive agent particle remaining in the shape of a particle, and a function of improving the adhesion with respect to the water-soluble resin of the pigment permeation layer 1600. In such a case, it is preferable that the drying temperature is set to be higher than or equal to the film formation temperature of the adhesive agent functioning as a binder and lower than or equal to a film formation temperature of the adhesive agent particle remaining in the shape of a particle. Thus, it is possible to make print properties of the ink jet and the adhesive transfer properties compatible such that the drying temperature is suitably selected according to the properties of the adhesive agent.

In addition, in the coating liquid of the adhesive agent, the moisture in the coating liquid is evaporated in the drying process, and thus, the concentration of the adhesive agent increases at the time of performing coating film formation. For this reason, the adhesive agent particles configuring the coating liquid of the adhesive agent are nearly dispersed as a single particle before being dried. However, in a case where the moisture in the coating liquid is evaporated in drying process, the concentration of the adhesive agent increases at the time of performing the coating film formation, and thus, there is a case where the dispersion of the adhesive agent particles is easily broken, and the plurality of particles are aggregated due to the collision or the union between the adhesive agent particles. The coating liquid of the adhesive agent is capable of forming a film even in such a state where the plurality of particles are aggregated, and thus, the adhesive agent can be discretely provided on the front surface of the pigment permeation layer 1600.

Accordingly, in a case where the adhesive agent is discretely provided by the single particle, the concentration of the coating liquid of the adhesive agent before being dried may decrease, and in a case where the adhesive agent is discretely provided in a state where the plurality of particles are aggregated, the concentration of the coating liquid of the adhesive agent before being dried may increase. Thus, the concentration of the coating liquid of the adhesive agent before being dried is suitably adjusted, and thus, a discrete state of the adhesive agent at the time of performing the film formation can be adjusted. The discrete state of the adhesive agent can be controlled according to an application of a transfer material and a printed material.

In addition, a coating film of the adhesive agent having tackiness may be disposed on a front surface of the transfer roller, the transfer film, or the like in a patchily discrete state through a peel-off layer 1701, and the coating film may be compressively transferred to the front surface of the pigment permeation layer 1600. According to this, a discrete pattern of the adhesive agent of which a front surface is formed on the transfer roller, the transfer film, or the like, can directly be transferred to the front surface of the pigment permeation layer 1600, and thus, the discrete state of the adhesive agent formed on the front surface of the pigment permeation layer 1600 can be arbitrarily controlled. According to such a method, it is not necessary to consider the permeation of the adhesive agent particle with respect to the air gap of the pigment permeation layer 1600, and thus, it is possible to discretely form the adhesive agent on the front surface of the pigment permeation layer 1600, without performing a special treatment with respect to the pigment permeation layer 1600 with soaking water or the like.

### (Preparing Method of Color Filter Transfer Object)

In the transfer material 1 of this embodiment, a dense pigment image is formed on the bottom of the pigment permeation layer 1600, and approximately the total amount of the water component and the solvent component 1607 of the pigment ink for a light transmission filter 1003 permeates in pigment permeation layer, by using the pigment permeation layer 1600 in which the pigment particles 1003a are capable of permeating and of being diffused. For this reason, the ink jet printing is performed is performed by using the pigment ink for a light transmission filter having excellent weatherability, and thus, it is possible to form a color filter image having high accuracy and high image quality at a high speed. A pigment ink for a light transmission filter is an aqueous ink in which color pigments are dispersed in a mixed solvent formed of water and a solvent. The color pigment is capable of converting white light into RGB. In addition, a light transmission filter using a black pigment ink can also be used in the light transmission filter, and the white light is not transmitted through a black pigment.

The aqueous pigment ink for a light transmission filter is a safe volatile component in which 60% to 80% of an ink component is water, alcohol, or the like as a solvent component, 20% to 30% of the ink component is the other solvent component, and 1% to 10% of the ink component is a pigment particle. In the aqueous pigment ink for a light transmission filter, most of the other solvent component is soluble in water, is nonvolatile, and is an inactive component (a component having low reactivity), and thus, is configured of a component having less acridness with respect to the human body. Accordingly, a pollutant solvent component is not continuously exhibited for a long period of time or a component having high activity does not remain in a state of being unreacted after an image is printed, and thus, safety is extremely high, and therefore, the aqueous pigment ink for a light transmission filter is particularly preferably used compared to a solvent ink mainly containing a volatile solvent, a UV ink using a monomer containing an active component (having high reactivity), or the like.

In the pigment ink for a light transmission filter 1003, an absorption state of the pigment ink for a light transmission filter 1003 is different according to the average particle diameter of the pigment particle 1606 of the ink, and the average pore diameter of each of the pigment permeation layer 1600 and the solvent absorption layer 1601. That is, a transfer material may be used in which the average pore diameter of the pigment permeation layer 1600 is larger than the average particle diameter of the pigment ink for a light transmission filter 1003 to be assumed, and is smaller than the average pore diameter of the solvent absorption layer.

In general, the average particle diameter of the pigment particle 1003a is approximately 40 nm to 110 nm. Accordingly, for example, in a case of using the pigment ink for a light transmission filter 1003 containing the pigment particle 1003a of a small particle size in which an image having high definition can be obtained, the average particle diameter of the pigment particle 1003a is approximately 40 nm to 50 nm. On the other hand, in the pigment ink for a light transmission filter 1003 using an inexpensive and stable pigment particle 1003a of a large particle size, the average particle diameter of the pigment particle 1606 is approximately 90 nm to 110 nm. For this reason, it is necessary to adjust the average pore size of the pigment permeation layer 1600 and the solvent absorption layer 1601 according to the pigment ink for a light transmission filter 1003 to be assumed. That is, a transfer material is used in which the size of the air gap of each of the pigment permeation layer 1600 and the solvent absorption layer 1601 is suitably combined with the size of the pigment particle 1003a, and thus, a dense pigment image having high definition can be formed on the interface between the pigment permeation layer 1600 and the solvent absorption layer 1601. In addition, approximately the total amount of the liquid component, which is the solvent of the pigment ink for a light transmission filter 1003, is rapidly absorbed in the solvent absorption layer 1601.

In a case where the ink is applied to the transfer material 1 by the ink jet printing, and then, the transfer material 1 overlaps with the image support 55, and the pressurizing and heating treatment is performed by using the heat roller 21 and the pressurizing roller 22, the pigment permeation layer 1600 is formed into a molten film, and the pigment retention film 1650 is adhesively transferred to the image support 55. After that, the solvent absorption layer 1601 is removed, and thus, the color filter transfer object 2016 containing the color filter 3 is prepared.

a self-dispersing pigment bonded with at least one type of functional group of a carbonyl group, a carboxyl group, a hydroxyl group, and a sulfone group, or salts thereof, or a resin-dispersing pigment in which a pigment particle is surrounded with a resin can be used as the pigment component of the pigment ink for a light transmission filter applied to the transfer material 1. In addition, the resin-dispersing pigment increases a binding force between the pigment particles after being separated from an ink medium, and thus, a rigid thin film-like pigment film can be formed on the bottom of the pigment permeation layer 1600. Approximately total amount of the solvent, which is the liquid component in the pigment ink for a light transmission filter, is absorbed in the solvent absorption layer 1601 of which the ink absorption speed is faster than that of the pigment permeation layer 1600, and thus, the solvent component 1607 of the pigment image rarely remains in the pigment permeation layer 1600. For this reason, resin-dispersing pigment particles are mutually close to each other, and are more rigidly bonded to each other by a dispersing resin added for pigment dispersion.

A known material can be used as the pigment used for the pigment ink for a light transmission filter is not particularly limited. The pigment may be independently used, or may be a plurality of pigments may be used by being mixed. In an example of the pigment used for the color filter application, Pigment yellow 83, 93, 110, and 139, Pigment orange 71, Pigment red 177 and 254, Pigment violet 23 and 37, Pigment blue 15 and 15:16, Pigment green 7 and 36, and the like are used as a color pigment, and specifically, CFAQ-010, CF AQ-023, CF AQ-016, and CF AQ-022, manufactured by MIKUNI COLOR LTD., Seikafast red, Seikafast yellow, Chromofine blue, Chromofine red, Chromofine green, Chromofine yellow, and the like, manufactured by Dainichiseika Color & Chemicals Mfg. Co., Ltd., are used. Pigment black 7 and the like are used as a black pigment, and specifically, Chromofine black manufactured by Dainichiseika Color & Chemicals Mfg. Co., Ltd. is used.

Furthermore, in this embodiment, in a case of obtaining higher brightness or contrast, a white filter can be further added in addition to three primary colors of RGB. A known inorganic fluorescent pigment or an organic fluorescent pigment, a phosphorescent pigment, or the like is used as such a pigment for a white filter. By adding the white filter containing the compound described above, it is possible to amplify a white color by exciting ultraviolet light, and to obtain higher brightness or contrast. Furthermore, it is preferable that an average particle diameter of the pigment for a white filter particle is identical to that of the RGB pigment particles described above.

In addition, it is preferable that a surface tension or a viscosity of an ink for ink jet printing is control as follows. That is, a preferred viscosity η of the pigment ink for a light transmission filter is 1.5 mPa·s to 10.0 mPa·s, a more preferred viscosity η is 1.6 mPa·s to 5.0 mPa·s, and an even more preferred viscosity η is 1.7 mPa·s to 3.5 mPa·s. On the other hand, it is preferable that a surface tension y of the ink is 25 mN/m to 45 mN/m. That is, the surface tension or the viscosity of the ink may be controlled such that the landed pigment ink for a light transmission filter 1003 is in contact with the front surface of the pigment permeation layer 1600 and then is rapidly absorbed in the pigment permeation layer 1600, and only the solvent component 1607 is rapidly absorbed in the solvent absorption layer 1601 side configured to have a capillary force which is significantly higher than that of the pigment permeation layer. In addition, the viscosity of the ink is suitably adjusted to be in the range described above, and thus, flowability of the ink at the time of ejecting the ink is improved, and ink feeding capability with respect to a nozzle, and stability of ink ejection are also improved. In addition, the surface tension of the ink is adjusted to be in the range described above, and thus, meniscus of an ink ejection port at the time of ejecting the ink can be maintained. Furthermore, even in a case where the adhesive agent is patchily provided on the front surface of the pigment permeation layer 1600, when a part of the ink landed on the print surface of the transfer material protrudes out from the adhesive agent and droops into the exposed portion of the ink receiving layer, it is possible to set the ink not to be torn in the front surface of the adhesive agent insofar as the surface tension or the viscosity of the ink is controlled in the range described above.

### (Pigment Concentration)

In this embodiment, a color material concentration in the ink is not particularly limited. Here, the color material concentration is preferably greater than or equal to 0.5% and less than or equal to 10%, and is more preferably greater than or equal to 1% and less than or equal to 5%. The color material concentration is set to be in such a range, and thus, it is possible to make visibility of an image and scratch properties compatible. In particular, in a case of the pigment ink for a light transmission filter 1003, in order to store approximately all of the pigment particle 1003a permeating in the pigment permeation layer 1600 in the pigment permeation layer 1600, it is necessary to strictly control the color material concentration corresponding to the air gap capacity of the pigment permeation layer 1600. That is, the air gap of the pigment permeation layer 1600 is filled with the pigment particles 1003a, and thus, it is necessary to control the color material concentration in a range where the pigment particles 1003a do not overflow. Further, in a range where the visibility of the image can be improved, it is preferable that a pigment concentration is as high as possible. The point is that the air gap capacity of the pigment permeation layer 1600 may be adjusted according to the pigment concentration or the print density such that all of the pigment particles 1606 can be received in the pigment permeation layer 1600. In addition, the transfer material 1 of this embodiment can be configured such that all of the solvent components can be absorbed in the solvent absorption layer 1601, which is a thick film, and thus, a pigment ink for a light transmission filter having a low concentration is overprinted, and therefore, it is possible to ensure the visibility of the image, and to further improve aptitude of the ink jet printing. That is, the ink concentration is controlled in the range described above, and the viscosity of the ink is controlled in an optimal state, and thus, it is possible to improve the flowability of the ink at the time of ejecting the ink, and to improve the ink feeding capability of the print head with respect to the nozzle, and the stability of ink ejection.

### (Ink Jet Printing Apparatus)

The ink is applied to the transfer material of this embodiment by using a printing apparatus using an ink jet printing method (an ink jet printing apparatus). The ink jet printing method is a method in which a pigment ink droplet for a light transmission filter is ejected with respect to the print surface of the print medium such as the transfer material for a filter from a plurality of nozzles formed on the print head, and thus, an image is printed. The type of ink jet printing method is not particularly limited, and both of thermal ink jet printing and a piezoelectric system can be used. In the ink jet printing apparatus, it is not necessary that the print head is in contact with the front surface of the pigment permeation layer 1600 of the transfer material 1, and it is possible to print an image which is extremely excellent and stable. In a serial scan system, the ink droplet ejected from the print head is set to be small, and thus, it is possible to easily print a high-quality image. In addition, in the serial scan system, in a case where the pigment ink for a light transmission filter is landed on the same print region by scanning of the print head a plurality of times with a predetermined temporal difference (divided overlapping scans), the ink absorption speed of the air gap absorption type pigment permeation layer 1600 is sufficiently faster than an evaporation speed of the pigment ink for a light transmission filter, and thus, the ink hardly remains in the front surface of the pigment permeation layer 1600 and high adhesive transfer properties can be maintained. On the other hand, in a case of a full line system, the ink is ejected from a multi-nozzle head in a direction intersecting with (for example, orthogonal to) an arrangement direction of the ejection ports, while the ink jet transfer material for a color filter is continuously conveyed, and thus, it is possible to print a high-quality image with high resolution at a high speed.

(Application of Pigment Ink for Light Transmission Filter with Respect to Transfer Material)

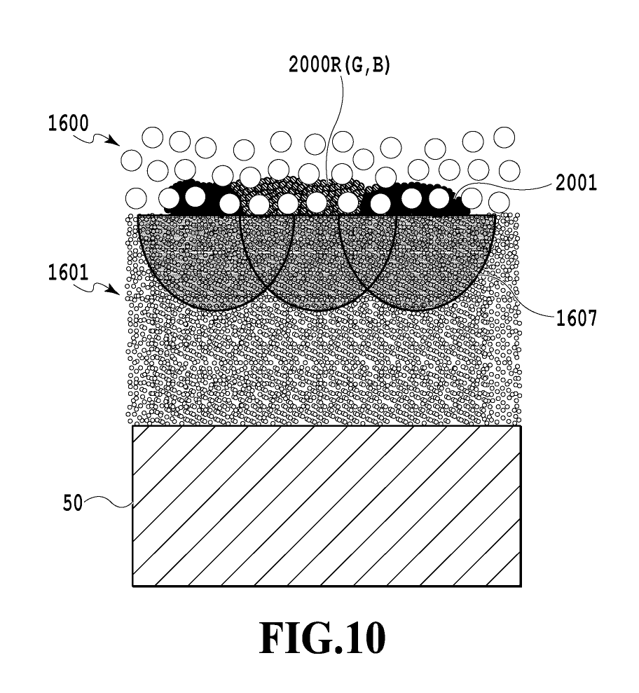

In this embodiment, first, a black pigment ink for a light transmission filter is ejected from a print head 2018Bk, and thus, a grid black matrix image 2001 (refer to FIG. 2D) is printed on the transfer material 1D. Accordingly, as illustrated in FIG. 10, the air gap structure formed on the bottom of the transfer material 1 is buried with a black pigment particle forming the black matrix 2001, this becomes a light shielding wall. Next, the pigment ink for a light transmission filter of each color (pigment inks for a light transmission filter of RGB) is applied to each of the plurality of frames formed by the black matrix image 2001. The pigment inks for a light transmission filter of three colors of RGB are respectively contained in the frames of the black matrix, and thus, it is possible to form a color filter image having high accuracy without having color bleeding, compared to a case where the black matrix is not formed in advance. When such a color filter image is formed, there is also a possibility that the ink droplet of the pigment ink for a light transmission filter slightly protrudes and is landed on the frame of the black matrix. However, the air gap on the bottom of the pigment permeation layer 1600 of the transfer material 1 is buried into the shape of a grid with the black pigment particle which is landed in advance, and flow path resistance of the liquid in the portion is larger than flow path resistance of an air gap structure portion in the frame where the ink is not applied. Accordingly, the pigment ink for a light transmission filter of the black matrix, which protrudes and is landed into the shape of a frame flows into the air gap structure portion in the frame where the pigment particle is not applied. Then, the RGB pigment particles are subjected to the solid-liquid separation on the interface between the pigment permeation layer 1600 and the solvent absorption layer 1601 in each of the frames, and are thinly and densely compressed and stacked.

The ink jet transfer material for a color filter of the invention includes the solvent absorption layer 1601 having sufficient solvent absorption capacity. Accordingly, as illustrated in FIGS. 3A and 3B, even in a case where overstriking printing of each color is performed three times by an ink jet printing apparatus including three rows of black pigment heads 2017 for a black matrix, three rows of R pigment heads 2018R, three rows of G pigment heads 2018G, and three rows of B pigment heads 2018R, all of the solvent components of the applied pigment ink for a light transmission filter can be absorbed in the solvent absorption layer 1601. Furthermore, the pigment particle is stacked in the air gap on the interface with respect to the bottom of the pigment permeation layer 1600 and the flow path resistance slightly increases whenever the printing is performed, but an air gap is generated between the pigment particles, and thus, the absorption of the solvent in the solvent absorption layer 1601 is not significantly impaired. Accordingly, according to the transfer material 1 of this embodiment, stable ink jet printing with high accuracy can be performed by using the pigment ink for a light transmission filter having a low concentration and excellent ink jet print aptitude. Further, even in a case where the pigment concentration is low, overprinting is performed three times, and thus, it is possible to form a color filter image having a high concentration. Even in a case of the overprinting, as illustrated in FIG. 3A, a black matrix image is printed by the black pigment head, and thus, the air gap structure on the interface with respect to the bottom of the pigment permeation layer 1600 is initially buried into the shape of a grid with the black pigment particle, and the light shielding wall is configured, and therefore, even in a case of performing high-concentration printing, it is possible to suppress color bleeding.

As described above, the transfer material 1 of this embodiment is configured of the pigment permeation layer 1600 having excellent ink absorptivity, and the solvent absorption layer 1601 which is a thick film, absorbs a mass of solvent component, and has large solvent absorption capacity, and thus, even in a case where the pigment ink for a light transmission filter is printed with high density at a high speed by high-speed color printing, the solvent component does not overflow from the solvent absorption layer 1601. In addition, the black matrix is formed into the shape of a frame by the black pigment ink for a light transmission filter, and then, the RGB pigment inks for a light transmission filter are printed, and thus, it is possible to form a color filter image having a high density and less color bleeding without mixing the adjacent pigment inks for a light transmission filter of different colors.

(Adhesive Transfer of Transfer Material with Respect to Image Support, and Removal of Solvent Absorption Layer)

### <Sticking Between Image Support 55 and Transfer Material>

The material of the image support 55 which is used together in the transfer material 1 of this embodiment, is not particularly limited. For example, the pigment retention film 1650 of the color filter image can be transferred to various transparent image supports 55 such as a transparent resin film and glass as the image support 55.

A transfer surface of the image support 55 overlaps with the print surface of the transfer material 1 on which the color filter image 2000 is printed, and then, the pigment permeation layer 1600 is formed into a molten film by the pressurizing and heating device, and thus, the pigment retention film 1650 is transferred to the image support 55. As necessary, a marking image for positioning may also be simultaneously printed at the time of printing the color filter image 2000 on the transfer material 1, and the overlapping may be performed while being positioned with a transfer position of the image support 55 with high accuracy.

### <Pressurizing and Heating Transfer Device and Pressurizing and Heating Transfer Step>

The transfer material 1 of this embodiment is scanned by a manually-operated heating iron or the like from the solvent absorption layer 1601 side or the image support 55 side of the transfer material 1, and thus, a sufficient pressure and sufficient heat are applied to the pigment permeation layer 1600, and the image support 55 can be subjected to heating and compressive bonding. In order to increase the productivity of the transfer object 1, a pressurizing and heating device using a known heat roller, a known heating fan, a known heating belt, a known heat transfer head, and the like may be used.

### <Heating and Compressive Bonding of Heat Roller>

In this embodiment, the pigment permeation layer 1600 is formed into a molten film by applying predetermined heat or a predetermined pressure, and thus, even in the pressurizing and heating treatment described above, it is preferable to adopt a configuration in which the heat roller and the pressurizing roller are used together, from the viewpoint of evenness of pressurizing and heating. Specifically, the pigment image (pigment film) 1606 is formed on the pigment permeation layer 1600 of the transfer material, and then, the transfer material on which the image is formed overlaps with the image support 55, and is conveyed between the heated heat roller 21 and the pressurizing roller 22. Accordingly, the pigment permeation layer 1600 is formed into a molten film, and the transfer material is adhesively transferred to the image support 55.

In addition, as described above, in a case where the pressurizing and heating treatment is performed by using the heat roller and the pressurizing roller together, it is important to control the heat or the pressure at the time of performing the heating and compressive bonding such that the air gap structure of the solvent absorption layer 1601 is maintained even in a case where the pigment permeation layer 1600 is formed into a molten film. As illustrated in FIG. 6, the transfer material 1 is subjected to the pressurizing and heating by the heat roller 21 and the pressurizing roller 22, and thus, the pigment permeation layer 1600 is formed into a molten film to enclose the pigment film 1606, and the pigment retention film 1650 is formed and is adhesively transferred to the image support 55. Here, the solvent component 1607 of the pigment ink for a light transmission filter 1003 which is absorbed in the solvent absorption layer 1601, still maintains the air gap structure. Thus, even in a case of performing the heating and compressive bonding, the solvent absorption layer 1601 maintains the air gap structure, and thus, it is possible to prevent the solvent component 1607 from causing adhesive impairment by seeping out in the pigment permeation layer 1600. In addition, the air gap structure is maintained, and thus, even in a case where the liquid component of the ink is bumped in the air gap of the solvent absorption layer 1601 by the heat or the pressure at the time of performing the heating and compressive bonding, and vapor is generated, it is possible to seal the vapor in each air gap. For this reason, an air layer or the like is hardly formed in the pigment retention film 1650 or an area with respect to the transfer surface of the image support 55, and the pigment retention film 1650 can be properly and adhesively transferred to the image support 55.

A temperature in the heating and compressive bonding is controlled such that the temperature is higher than or equal to a temperature at which the resin particulates of the pigment permeation layer 1600 are formed into a molten film. Thus, the pigment permeation layer 1600 forms a film to enclose the pigment film 1606, and completely immobilizes the pigment particle 1003a. For this reason, the rigid pigment retention film 1650 can be adhesively transferred to the image support 55. In addition, in a case of using the transfer material 1 in which the adhesive agents 1000A and 1000B are discretely provided on the front surface of the pigment permeation layer 1600, a heating temperature is controlled such that the heating temperature is higher than or equal to the temperature at which the adhesive agent is formed into a molten film. The discretely provided adhesive agent is integrated with the pigment permeation layer 1600 and adheres to the image support 55, and thus, the pigment image retention film 1650 can be rigidly and adhesively transferred. In addition, it is important to control the heating temperature such that the air gap structure is maintained even after the heating and compressive bonding is performed without destroying the air gap structure of the solvent absorption layer 1601 more than is necessary. In addition, the pigment ink for a light transmission filter solvent component retained in the solvent absorption layer 1601 is configured not to bump into each of the air gaps or to be evaporated, and thus, it is possible to prevent a decrease in a heating efficiency of an evaporation heat. Accordingly, it is preferable that the transfer is performed at a temperature lower than or equal to a boiling point of water.

In the consideration of the inventors, a preferred result is obtained by setting a pressure in the heating and compressive bonding to be greater than or equal to 0.5 kg/cm and less than or equal to 7.0 kg/cm. By setting the pressure in the heating and compressive bonding to be greater than or equal to 0.5 kg/cm, the pigment permeation layer forms a film to enclose the pigment film, and thus, it is possible to completely immobilize the pigment particle, and to form a rigid pigment retention film. On the other hand, by setting the pressure in the heating and compressive bonding to be less than or equal to 7.0 kg/cm and the air gap to be maintained without destroying the air gap structure of the solvent absorption layer 1601 more than is necessary, it is possible to prevent a nonvolatile solvent, which is the liquid component of the ink, from seeping out in the front surface, and to excellently adhesively transfer the pigment retention film to the image support 55.

In the heat roller 21, it is preferable that a fluorine resin layer having excellent heat resistance and releasability is disposed on a front surface of a heating source built-in metal tube. Further, a fluorine rubber layer or the like may be laminated as an elastic layer for obtaining a desired heating compressive bonding width. In addition, the function of the heat roller 21 can be realized by a film type heating and compressive bonding conveyance body including a plate-like ceramic heater as a heating member, and a heat transfer convey member in which a heat resistant release layer is disposed on a front surface of a heat resistant film. Polyimide or the like can be used as the heat resistant film, and a fluorine resin layer, a fluorine rubber layer, or the like can be used as the heat resistant release layer. In addition, it is preferable that a silicone roller is used as the pressurizing roller 22. The silicone roller has a release function, and thus, even in a case where the front surface of the pigment permeation layer 1600 is directly in contact with the pressurizing roller 22, the front surface of the pigment permeation layer 1600 hardly adheres to the pressurizing roller 22. A fluorine resin front surface having excellent releasability is further laminated on the front surface of the silicone roller, and thus, a configuration having excellent releasability and pressurizing and heating properties can be obtained.

A known laminator such as D-10 manufactured by DYNIC CORPORATION or LPD3223 CLIVIA manufactured by FUJITEX Co., Ltd. can be used as a specific device of transferring the ink jet transfer material for a color filter to the image support 55 and of peeling off the substrate 50. The laminator includes a pair of heat rollers 21 and a pair of pressurizing rollers 22, and when the image support 55 and the transfer material 1 pass through the rollers, the pigment permeation layer 1600 of the transfer material may be subjected to the heating and compressive bonding with respect to the image support 55.

### (Removing Device and Removing Step of Solvent Absorption Layer)

As illustrated in FIG. 7A, a predetermined peel-off angle is applied to the solvent absorption layer 1601, which is a thick film, by the peeling roller 2006 or the like after the adhesively transferring step, and the transfer material 1 and the peeling roller 2006 can be peeled off and removed. Further, the release layer is disposed on the peeling roller 2006, and thus, it is possible to more easily perform the peeling. In a case where the solvent absorption layer 1601 is disposed on the substrate 50 in order to improve conveying performance or the like, the peel-off angle can be applied at a higher tension, and thus, the solvent absorption layer 1601 is also easily peeled off and removed along with the substrate 50. That is, when the predetermined peel-off angle is applied to the image support 55, and the solvent absorption layer 1601 is peeled off at the angle, there is a case where the solvent absorption layer 1601 maintaining the air gap structure easily expands in a case where a large peel-off tension is applied. Accordingly, the substrate 50, which hardly expands and contracts, is used together by cohering to the solvent absorption layer 1601, and the peel-off tension is applied to the substrate 50, and thus, the peeling can be performed at a stable angle.

In addition, as illustrated in FIG. 7B, the solvent absorption layer 1601 may be dissolved and removed according to a dissolution washing step in which the dissolution liquid is absorbed in the air gap structure of the solvent absorption layer 1601 immersed in the dedicated dissolution liquid 2007, and then, is washed. The dissolution liquid 2007 is a solvent in which a bonding resin forming the air gap structure of the solvent absorption layer 1601 can be dissolved, and it is preferable to use a material which hardly deteriorates the pigment retention film 1650 which is formed into a molten film, the pigment particle, and the image support 55.

### (Color Filter Manufacturing Apparatus and Manufacturing Method)

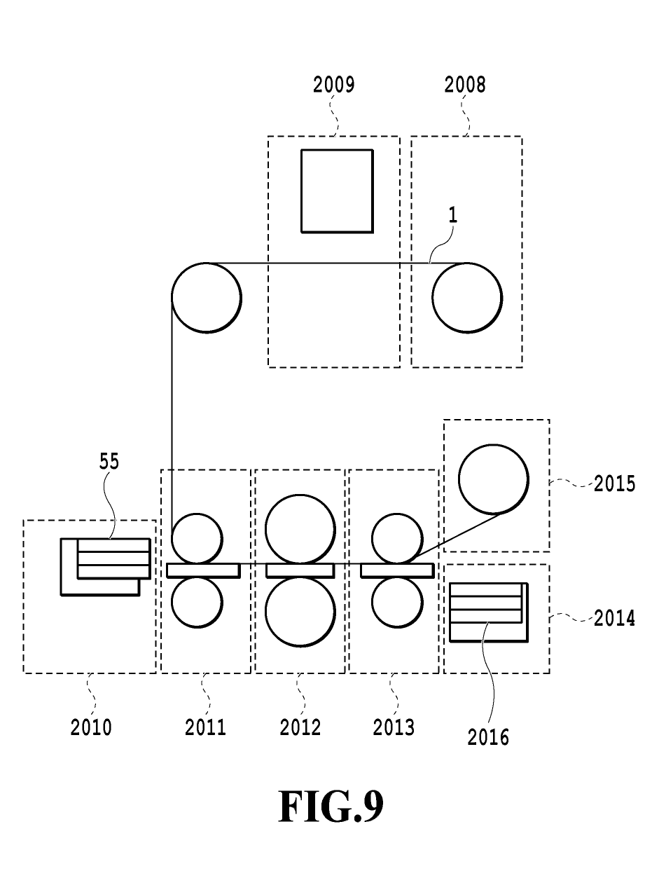

FIG. 9 is a diagram schematically illustrating a manufacturing the color filter transfer object 2016 including the color filter 3 by using the transfer material 1 for a color filter described above. In this embodiment, the color filter manufacturing apparatus integrally includes a feeding unit 2008, an ink jet printing unit (an ink applying unit) 2009, an image support feeding unit 2010, a positioning unit 2011, a pressurizing and heating unit 2012, a peeling and removing unit 2013, a solvent absorption layer collecting unit 2015, and a discharge unit 2016. The feeding unit 2008 is a portion sequentially feeding the transfer material 1 for a color filter to the ink jet printing unit 2009. The ink jet printing unit 2009 ejects the color pigment inks for a light transmission filter of RGB or the like, and the black pigment ink for a light transmission filter to the transfer material 1 for a color filter fed from the feeding unit 2008, and forms a color filter image on the transfer material 1 for a color filter. The positioning unit 2011 allows the transfer material 1 for a color filter to which the pigment ink for a light transmission filter is applied by the ink jet printing unit 2009, to overlap with the image support 55 fed from the feeding unit 2008, and feeds the transfer material 1 for a color filter and the image support 55 to the pressurizing and heating unit 2012. The pressurizing and heating unit 2012 performs the pressurizing and heating treatment with respect to the transfer material 1 for a color filter to which the pigment ink for a light transmission filter is applied by the ink jet printing unit 2009, and forms solvent absorption layer 1601 or a part of the solvent absorption layer 1601 (for example, the first solvent absorption layer 1611) into a molten film. The pigment retention film 1650 or the protective film 1660 as illustrated in FIG. 2C is formed on the transfer material 1 for a color filter through such a step. In the peeling and removing unit 2013, at least a part of the solvent absorption layer 1601 is removed from the transfer material 1 subjected to the pressurizing and heating treatment. For example, as illustrated in FIGS. 1D and 1E, in a case where the solvent absorption layer 1601 is formed of two layers, the second solvent absorption layer 1612 containing the solvent component is removed. Furthermore, in a case of using the transfer material 1 and the substrate 50 together, the substrate 50 is also removed by the peeling and removing unit 2013. Accordingly, as illustrated in FIG. 2D, the color filter transfer object 2016 is manufactured by the color filter 3 configured of a transparent pigment retention film 1650, which is formed into a molten film in order to enclose the color filter image 2000, and a transparent image support 55 such as glass. In the transfer object 2016 for a color filter illustrated in FIG. 2D, the protective film 1660 is disposed in which the first solvent absorption layer 1611 is formed into a molten film, in consideration of weatherability or the like of the color filter 3. However, the filter and the transfer object for a color filter according to the invention can be configured not to include the protective film 1660.

As described above, in the color filter manufacturing apparatus of this embodiment, all of the manufacturing steps described above can be performed in one device. However, the manufacturing steps can be respectively performed in independent devices. That is, in consideration of productivity or the like, it is possible to manufacture the color filter and the color filter transfer object by using independent devices such as an ink jet printing apparatus, an image supporting and overlapping device, a pressurizing and heating transfer device, and a solvent absorption layer removing device.

### (Color Filter Transfer Object)

The color filter transfer object of this embodiment has a configuration in which the pigment retention film 1650 formed into a molten film is adhesively transferred to a transparent image support 55 such as a glass plate or a resin film in order to enclose the pigment particle. The solvent absorption layer 1601 absorbing a mass of solvent component of the pigment ink for a light transmission filter while maintaining the air gap structure is removed after being adhesively transferred to the image support 55, and thus, as illustrated in FIGS. 2D and 2E, a color filter is obtained in which a haze reduction is extremely small and selective absorptivity of transmission light is excellent. The solvent absorption layer 1601, which is a thick film, has sufficient solvent absorption capacity, and thus, it is possible to overprint a mass of pigment ink for a light transmission filter. Further, the pigment particle is not diffused and does not permeate in the planar direction which is approximately identical to the film thickness of the pigment permeation layer 1600, which is a thin film, and thus, it is possible to form a thin and dense pigment film. Accordingly, in this embodiment, the transfer material 1 of the color filter is used, and thus, it is possible to prepare a color filter having a high concentration, a high accuracy, and less bleeding. In addition, the grid black matrix is printed by using the black pigment ink for a light transmission filter before the pigment ink for a light transmission filter of each color of RGB is printed, and thus, it is possible to bury in advance the air gap on the interface with respect to the bottom of the pigment permeation layer 1600 with the black pigment particle. For this reason, the pigment particle each color of RGB protrudes from each frame of the black matrix corresponding to the pixel, and thus, color bleeding hardly occurs. In addition, the pigment permeation layer 1600 is formed into a molten film to enclose the pigment particle, which is a color material, and forms a transparent protective film of the pigment film 1606, and thus, it is possible to completely immobilize the pigment particle, and the pigment retention film 1650 formed into a molten film rigidly adheres to the image support 55. Further, in a case where the first solvent absorption layer 1611 is formed into a molten film, and the transparent protective film is also transferred, more stable light absorption transmissivity can be maintained for a long period.

Hereinafter, specific examples of the invention will be described. Here, the invention is not limited to the following examples. Furthermore, and in the following description, “pts” and “%” refer to mass standards unless otherwise specified.

### (Substrate A)

A PET substrate 50 (Product Name: “Tetoron G2”, Thickness: 50 μm, manufactured by Teijin Film Solutions Limited) was used as a substrate A.

### (Preparation of Water-Soluble Resin Solution 1)

Polyvinyl alcohol (Product Name “PVA235”, manufactured by KURARAY CO., LTD) was dissolved in ion exchange water, and thus, a water solution resin solution 1 having a solid content of 8% was prepared. Furthermore, in polyvinyl alcohol, an average degree of polymerization was 2300, and a degree of saponification was 87 mol % to 89 mol %.

### (Preparation of Water-Soluble Resin Solution 2)

Product Name “NS-625” (manufactured by Takamatsu Oil & Fat Co., Ltd.) was dissolved in ion exchange water, and thus, a water-soluble resin solution 2 having a solid content of 8% was prepared as an acrylic water-soluble resin.

### (Preparation of Solvent Absorption Layer Coating Liquid Y1)

A first glass reaction container was provided with a stirrer, a reflux condenser, a thermometer, and a nitrogen gas introduction pipe, and then, 6 g of Aqualon RN-30 (manufactured by DKS Co., Ltd.) as a nonionic emulsifier, 6 g of Aqualon HS-30 (manufactured by DKS Co., Ltd.) as an anionic emulsifier, 100.0 g of methyl methacrylate, 20.0 g of ethyl acrylate, 10.0 g of 2-hydroxyl ethyl acrylate, and 5.0 g of a methacrylic acid were used, 275 g of water was put thereto and stirred, and thus, a mixture of the total amount of 427.0 g was adjusted. Next, 36 g of the mixture was extracted, and was moved to a similar second reaction container, and then, was emulsified at 73° C. for 40 minutes with nitrogen gas introduced into the second reaction container. Next, 17 g of ammonium peroxodisulfate was dissolved in 36 g of water, and was added to the emulsifier, as a polymerization initiator. After that, the remaining amount of the mixture was extracted by the first reaction container for 100 minutes, and was gradually dripped into the second reaction container, and was polymerized at 73° C. The remaining mixture was completely dripped, and then, stirring was continuously performed at 73° C. for 80 minutes, and thus, a water solution 1 of emulsion (Tg: 78° C., a resin solid content of 35.0%) was synthesized. An average primary particle size of the dispersed particles was 40 nm. Next, 100 pts of the water solution 1 of emulsion and 43.75 pts of the polyvinyl alcohol water solution 1 were added, and were mixed by a static mixer, and thus, a solvent absorption layer coating liquid Y1 was obtained.

### (Preparation of Solvent Absorption Layer Coating Liquid Y2)

100 pts of a silica water solution (Product Name “SNOWTEX 0” (a solid content (SiO2) concentration of 20%, an average particle diameter of 10 nm), manufactured by Nissan Chemical Industries, Ltd.) and 50 pts of a water-soluble resin water solution 2 were added, and were mixed by the static mixer, and thus, a solvent absorption layer coating liquid Y2 was obtained.

### (Preparation of Pigment Permeation Layer Coating Liquid G1)

As with the water solution 1 of emulsion, a water solution 3 of emulsion having a solid content concentration of 20%, an average primary particle diameter of 180 nm, and Tg of 78° C. was obtained by suspension polymerization. Furthermore, Aqualon RN-30 (manufactured by DKS Co., Ltd.) as the nonionic emulsifier and Aqualon HS-30 (manufactured by DKS Co., Ltd.) as the anionic emulsifier were not used. Next, 100 pts of the water solution 3 of emulsion and 25 pts of the water-soluble resin solution 2 were added, and were mixed by the static mixer, and thus, a pigment permeation layer coating liquid G1 was obtained.

### (Preparation of Pigment Permeation Layer Coating Liquid 2)

As with the water solution 1 of emulsion, a water solution 4 of emulsion having a solid content concentration of 20%, an average primary particle diameter of 120 nm, and Tg of 78° C. was obtained by suspension polymerization. Next, 100 pts of the water solution 3 of emulsion and 25 pts of the water-soluble resin solution 2 were added, and were mixed by the static mixer, and thus, a pigment permeation layer coating liquid 2 was obtained.

### (Preparation of Enhanced Adhesive Layer Reinforcing Material Coating Liquid S1)

10 pts of Chemipearl V-300 of manufactured by Mitsui Chemicals, Inc. (a solid content concentration of 40%, an average secondary particle diameter 6 μm) and 90 pts of ion exchange water were stirred and mixed for 5 minutes, and thus, an enhanced adhesive layer coating liquid S1 was obtained.

### (Preparation of Release Agent Coating Liquid R1)

PORIRON 788 manufactured by CHUKYO YUSHI CO., LTD. was used as a release agent.

### (Adjustment of RGBK Pigment Inks for Light Transmission Filter)

23 g of CF AQ-023 (manufactured by MIKUNI COLOR LTD., a pigment water dispersion liquid) was mixed into a solution of 100 pts.wt. of water/50 pts.wt. of ethylene glycol, and was stirred by a beads mill, and a hydrochloric acid was added thereto, and thus, R ink for a red pixel of pH3 was prepared. An average secondary particle diameter of an R pigment ink for a light transmission filter of the red pixel was 51 nm. Similarly, a B pigment ink for a light transmission filter of a blue pixel was prepared by using 20 g of CF AQ-010 (manufactured by MIKUNI COLOR LTD., a pigment water dispersion liquid). An average secondary particle diameter of the B pigment ink for a light transmission filter of the blue pixel was 52 nm. Similarly, a G pigment ink for a light transmission filter of a green pixel was prepared by using 21 g of CF AQ-016 (manufactured by MIKUNI COLOR LTD., a pigment water dispersion liquid). An average secondary particle diameter of the G pigment ink for a light transmission filter of the green pixel was 53 nm. Similarly, a black pigment ink for a light transmission filter of a black matrix was prepared by using g of CF AQ-022 (manufactured by MIKUNI COLOR LTD., a pigment water dispersion liquid). An average secondary particle diameter of the black pigment ink for a light transmission filter of the black matrix was 50 nm.

### Example 1

Next, Example 1 of the invention will be described with reference to FIG. 6.

### (Adjustment of Transfer Material T1)

The solvent absorption layer coating liquid 2 was applied onto the front surface of the substrate A and was dried, and thus, the solvent absorption layer was formed on the substrate A, as the constituent of the transfer material. A coating amount after being dried was 40 g/m². The thickness of the solvent absorption layer was 40 μm. The release agent coating liquid 1 was applied onto the front surface of the solvent absorption layer to be extremely thin such that the permeation and absorption of the ink solvent was not hindered, and thus, the peel-off layer was disposed. Further, the pigment permeation layer coating liquid G1 was applied onto the front surface of the release layer while being treated with dampening water, and then, was dried, and thus, a transfer material T1 including the substrate A, the solvent absorption layer, and the pigment permeation layer was manufactured, as the constituent of the transfer material. A coating amount after being dried was 3 g/m². The thickness of the pigment permeation layer was 3 μm. The solvent absorption layer and the pigment permeation layer were applied by using a gravure coater, a coating speed was 5 m/minute, and a drying temperature was 60° C. In the transfer material T1, a pore diameter of the air gap of the pigment permeation layer and a pore diameter of the air gap of the solvent absorption layer were measured by a BET method. The pore diameter of the air gap of the pigment permeation layer was 180 nm, and the pore diameter of the air gap of the solvent absorption layer was 10 nm.

### (Manufacturing of Color Filter F1)

A color filter image was printed on the transfer material 1 by using the pigment ink for a light transmission filter described above in sequential ink jet printing. In the image printing, first, a grid image was printed by the black pigment ink for a light transmission filter, and thus, the black matrix was formed. Next, each color of RGB was printed. The transfer material including the color filter image was subjected to pressurizing and heating adhesion (transfer) on a front surface of glass, which is an image support, by the heat roller and the pressurizing roller, along with the pigment permeation layer 1600. After that, the substrate A and the solvent absorption layer 1601 containing approximately all of ink solvent components 1607 were peeled off through the peel-off layer, and thus, a color filter F1 of Example 1 was obtained.

### Example 2 (Manufacturing Example 2)

### <Adjustment of Transfer Material T2>

The solvent absorption layer coating liquid Y2 was dried while being applied onto the front surface of the substrate A, and thus, the second solvent absorption layer 1612 was formed on the substrate A, as the constituent of the transfer material. A coating amount after being dried was 40 g/m². The thickness of the second solvent absorption layer 1612 was 40 μm. A release agent coating liquid R1 was applied onto the front surface of the second solvent absorption layer 1612 to be extremely thin such that the permeation and absorption of the ink solvent was not hindered, and thus, the peel-off layer was disposed. Further, the solvent absorption layer coating liquid Y1 was applied onto the front surface of the release layer while being treated with dampening water, and was dried, and thus, the first solvent absorption layer 1611 was formed. A coating amount after being dried was 10 g/m². Further, the pigment permeation layer coating liquid G1 was applied onto the front surface of the first solvent absorption layer 1611, and was dried, and thus, a transfer material T2 including the substrate A, the second solvent absorption layer 1612, the first solvent absorption layer 1611, and the pigment permeation layer 1600 was manufactured, as the constituent of the transfer material. A coating amount after being dried was 3 g/m². The thickness of the pigment permeation layer 1600 was 3 μm. The second solvent absorption layer 1612, the first solvent absorption layer 1611, and the pigment permeation layer 1600 were applied by using a gravure coater, a coating speed was 5 m/minute, and a drying temperature was 60° C. In the transfer material 1, a pore diameter of the air gap of the pigment permeation layer 1600 and a pore diameter of the air gap of the solvent absorption layer 1601 were measured by a BET method. The pore diameter of the air gap of the pigment permeation layer 1600 was 180 nm, a pore diameter of the air gap of the second solvent absorption layer 1612 was 10 nm, and a pore diameter of the air gap of the first solvent absorption layer 1611 was 40 nm.

### <Manufacturing of Color Filter F2>

In the ink jet printing, first, the black pigment ink for a light transmission filter was printed on the transfer material T2 into the shape of a grid, and thus, the black matrix was formed. Next, each color of RGB was printed. The transfer material including the color filter image was subjected to the pressurizing and heating adhesion (transfer) on a front surface of glass, which is an image support, by the heat roller and the pressurizing roller, along with the pigment permeation layer 1600. After that, the substrate 50 and the second solvent absorption layer 1612 containing approximately all of the ink solvent components 1607 were peeled off through the peel-off layer, and thus, a printed material 2 of Example 1 was obtained. Furthermore, the first solvent absorption layer 1611 formed on a color filter F2 was formed into a molten film, and was formed on the front surface of the pigment retention film formed into a molten film such that the pigment permeation layer 1600 enclosed the pigment particle, as the transparent protective layer.

### Example 3 (Manufacturing Example 3)

### <Adjustment of Transfer Material T3>

The solvent absorption layer coating liquid Y2 was dried while being applied onto the front surface of the substrate A, and thus, the solvent absorption layer 1601 was formed on the substrate A, as the constituent of the transfer material. A coating amount after being dried was g/m². The thickness of the solvent absorption layer 1601 was 40 μm. The release agent coating liquid R1 was applied onto the front surface of the solvent absorption layer 1601 to be extremely thin such that the permeation and absorption of the ink solvent was not hindered, and thus, the peel-off layer was disposed. Further, the pigment permeation layer coating liquid G2 was applied onto the front surface of the release layer while being treated with dampening water, and was dried, and thus, the first pigment permeation layer 1670 was formed. A coating amount after being dried was 5 g/m². Further, the pigment permeation layer coating liquid G1 was applied onto the front surface of the first pigment permeation layer 1670, and then, was dried, and thus, a transfer material T3 including the substrate A, the solvent absorption layer 1601, the first pigment permeation layer 1670, and the second pigment permeation layer 1680 was manufactured as the constituent of the transfer material. A coating amount after being dried was 3 g/m². The thickness of the pigment permeation layer 1600 was 3 μm. The solvent absorption layer 1601, the first pigment permeation layer 1670, and the second pigment permeation layer 1680 were applied by using a gravure coater, a coating speed was 5 m/minute, and a drying temperature was 60° C. In the transfer material T1, the pore diameter of the air gap of the pigment permeation layer 1600 and the second pigment permeation layer 1680, and the pore diameter of the air gap of the solvent absorption layer 1601 were measured by a BET method. The pore diameter of the air gap of the solvent absorption layer 1601 was 10 nm, the pore diameter of the air gap of the first pigment permeation layer 1670 was 120 nm, and the second pigment permeation layer was 180 nm.

### <Manufacturing of Color Filter F3>

In the ink jet printing, first, a color filter image was printed on the transfer material T3 into the shape of a grid by the black pigment ink for a light transmission filter, and thus, the black matrix was formed. Next, each color of RGB was printed. The transfer material including the color filter image was subjected to the pressurizing and heating adhesion (transfer) on a front surface of glass, which is an image support A, by the heat roller and the pressurizing roller, along with the pigment permeation layer 1600. After that, the substrate A and the solvent absorption layer 1601 containing approximately all of the ink solvent components 1607 were peeled off through the peel-off layer, and thus, a color filter F3 of Example 3 was obtained. Furthermore, the first and second pigment permeation layers 1670 and 1680 formed on the color filter F3 were formed into a molten film, and thus, excellently adhered to the image support 55.

### Example 4 (Manufacturing Example 4)

### <Adjustment of Transfer Material 14>

A transfer material T4 was obtained by the same method as that in Example 2, except that the release layer was not disposed in the transfer material T2.

### <Manufacturing of Color Filter F4>

In the ink jet printing, first, a color filter image was printed on the transfer material T4 into the shape of a grid by using the black pigment ink for a light transmission filter, and thus, the black matrix was formed. Next, each color of RGB was printed. The transfer material including the color filter image was subjected to the pressurizing and heating adhesion (transfer) on a front surface of glass, which is the image support 55, by the heat roller and the pressurizing roller, along with the pigment permeation layer 1600. After that, the glass to which a film adhered was immersed in a DMSO solution for 15 minutes, and the substrate 50 and the second solvent absorption layer 1612 containing approximately all of the solvent components 1607 were peeled off, and thus, a color filter F4 of Example 4 was obtained. Furthermore, the pigment permeation layer 1600 formed on the color filter F4 was formed into a molten film, and excellently adhered to the image support 55, and thus, the first solvent absorption layer 1611 was also formed into a molten film, and an excellent transparent protective film was formed.

### Example 5 (Manufacturing Example 5)

### <Adjustment of Transfer Material T5>

The enhanced adhesive layer coating liquid S1 was applied onto the front surface of the pigment permeation layer 1600 of the transfer material T1, and then, was dried, and thus, a transfer material T5 including the solvent absorption layer 1601, the peel-off layer, and the pigment permeation layer 1600 on the substrate 50, and the enhanced adhesive layer in which the adhesive agent was discretely provided on the front surface of the pigment permeation layer 1600, was manufactured, as the constituent of the transfer material. A coating amount after being dried was 1.5 g/m². The thickness of the enhanced adhesive layer was 1.5 μm. The enhanced adhesive layer was applied by using a gravure coater, a coating speed was 5 m/minute, and a drying temperature was 60° C.

### <Manufacturing of Color Filter F5>

In the ink jet printing, first, a color filter image was printed on the transfer material T5 into the shape of a grid by using the black pigment ink for a light transmission filter, and thus, the black matrix was formed. Next, each color of RGB was printed. The transfer material including the color filter image was subjected to the pressurizing and heating adhesion (transfer) on a front surface of glass, which is the image support 55, by the heat roller and the pressurizing roller, along with the pigment permeation layer 1600. After that, the substrate and the solvent absorption layer 1601 containing approximately all of the solvent components were peeled off through the peel-off layer, and thus, a color filter F5 of Example 5 was obtained. Furthermore, the enhanced adhesive layer formed on the color filter F5 was formed into a molten film along with the pigment retention film, and thus, excellently adhered to the image support 55.

### Example 6 (Manufacturing Example 6)

### <Adjustment of Transfer Material T6>

A transfer material T6 was adjusted by the same method as that in Example 1, except that the thickness of the pigment permeation layer of the transfer material T1 of Example 1 was 10 μm.

### <Manufacturing of Color Filter F6>

A color filter image was printed on the transfer material T6 by sequential ink jet printing by using the pigment ink for a light transmission filter. In the image printing, first, a color filter image was printed by the RGB pigment inks for a light transmission filter. After that, the color filter image was printed into the shape of a grid by the black pigment ink for a light transmission filter, and thus, the black matrix was formed. The transfer material including the color filter image was subjected to the pressurizing and heating adhesion (transfer) on a front surface of glass, which is an image support, by the heat roller and the pressurizing roller, along with the pigment permeation layer 1600. After that, the substrate A and the solvent absorption layer 1601 containing approximately all of the ink solvent components 1607 were peeled off through the peel-off layer, and thus, a color filter F6 of Example 6 was obtained.

### Comparative Example 1

### <Adjustment of Transfer Material T7>

The release agent coating liquid R1 was applied onto the front surface of the substrate 50A to be extremely thin, and then was dried, and thus, the peel-off layer was formed on the substrate 50A, as the constituent of the transfer material. The pigment permeation layer coating liquid G1 was applied onto the front surface of the peel-off layer, and was dried, and thus, a transfer material T6 was manufactured. A coating amount after being dried was 40 g/m². The thickness pigment permeation layer 1600 was 40 μm. The pigment permeation layer 1600 was applied by using a gravure coater, a coating speed was 5 m/minute, and a drying temperature was 60° C. In addition, the pore diameter of the air gap of the solvent absorption layer 1601 was 180 nm.

### <Manufacturing of Color Filter F7>

In the ink jet printing, first, a color filter image was printed on the transfer material T7 into the shape of a grid by the black pigment ink for a light transmission filter, and thus, the black matrix was formed. Next, each color of RGB was printed. The transfer material including the color filter image was subjected to the pressurizing and heating adhesion (transfer) on a front surface of glass, which is the image support 55, by using the heat roller and the pressurizing roller, along with the pigment permeation layer 1600. After that, the substrate 50 was peeled off through the release layer, and thus, a color filter F7 of Example 6 was obtained. The pigment permeation layer 1600, which is a thick film, was formed into a molten film, and partially adhered to the image support 55, but there was a portion where the pigment particle remained on the adhesive transfer surface, or the solvent component seeped out and caused an adhesion defect. The color filter image itself of the color filter T7 had large bleeding and low resolution, and the pigment particles were dispersed, and thus, a color filter was obtained in which a thin and dense pigment film was not formed, and an image concentration was also low.

According to Examples 1 to 6, the transfer material was subjected to the pressurizing and heating along with image support 55, and thus, was capable of being excellently adhesively transferred. In addition, a large amount of the solvent was capable of being absorbed in the solvent absorption layer 1601, which is a thick film, and thus, an ink print density was capable of being obtained at a high concentration, and a pigment film having a high concentration was capable of being formed.

The transfer material for a color filter of this example was transferred onto the image support 55 after being subjected to the ink jet printing, and then, the solvent absorption layer 1601 absorbing the solvent component, which is a thick film, was removed along with the substrate A, and thus, a thin and dense pigment film having a small haze reduction was capable of being formed on the image support 55. That is, the pigment permeation layer 1600, which is a thin film (the thickness of the pigment permeation layer was controlled such that the thickness was greater than or equal to 1 μm and less than or equal to 10 μm), and thus, excessive bleeding of the pigment particle was suppressed, and a mass of solvent component was absorbed by the solvent absorption layer 1601, which is a thick film, and then, was adhesively transferred to the image support 55, and then, was removed. Accordingly, the pigment ink for a light transmission filter having a low concentration, in which ink jet aptitude was enhanced without forcedly increasing the concentration of the pigment particulates, was overstruck a plurality of times, and thus, a thin and dense pigment film having a high concentration was capable of being stably formed. In addition, in Examples 1 to 5, the thickness of the pigment permeation layer was formed into a thin film compared to Example 6, and the black matrix was formed in advance by the black pigment ink for a light transmission filter, and thus, the air gap structure on a color boundary portion of the pigment permeation layer 1600 was buried with the black pigment particle, and then, was subjected to coloring by the pigment ink for a light transmission filter of each color of RGB, and thus, a color filter transfer object having more excellent light shielding properties and smaller color bleeding compared to Example 6, was capable of being integrally prepared by a simple configuration and simple step. Further, in Examples 1 to 6, when the pigment permeation layer 1600 in which the pigment film was formed on the bottom, was subjected to the heating and pressurizing, and was adhesively transferred to the image support 55, the pigment retention film was formed by being formed into a molten film in order to enclose the pigment particle, and the pigment particle itself originally having excellent weatherability was also prevented from being directly exposed, and thus, the optical properties of the pigment particle were further stabilized. For this reason, the color filter transfer object of the invention has a small time deterioration in the optical properties and excellent long-term usability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-027972 filed Feb. 17, 2017, which is hereby incorporated by reference wherein in its entirety.

What is claimed is:

1. A manufacturing method of a light transmission filter, comprising:
an ink applying step of applying a pigment ink for a light transmission filter to an ink receiving layer formed by mutually laminating a pigment permeation layer which is capable of allowing a pigment particle and a solvent contained in the pigment ink to permeate, and a solvent absorption layer having an air gap structure which is capable of inhibiting permeation of the pigment particle and of absorbing the solvent, from the pigment permeation layer side; and
a solvent absorption layer removing step of removing at least a part of the solvent absorption layer containing a solvent component of the pigment ink from the ink receiving layer.

2. The manufacturing method of a light transmission filter according to claim 1,
wherein a thickness of the pigment permeation layer is 1 μm to 10 μm.

3. The manufacturing method of a light transmission filter according to claim 1,
wherein the pigment particle applied to the pigment permeation layer is sequentially stacked in the pigment permeation layer from an interface between the solvent absorption layer and the pigment permeation layer.

4. The manufacturing method of a light transmission filter according to claim 1, further comprising:
a melting step of forming the pigment permeation layer into a molten film, between the ink applying step and the solvent absorption layer removing step.

5. The manufacturing method of a light transmission filter according to claim 4,
wherein in the melting step, the pigment permeation layer is formed into a molten film to wrap up the pigment particle which is stacked in the pigment permeation layer.

6. The manufacturing method of a light transmission filter according to claim 1,
wherein the solvent absorption layer is configured to be removable from the pigment permeation layer.

7. The manufacturing method of a light transmission filter according to claim 1,
wherein the solvent absorption layer is formed of a first solvent absorption layer which is in contact with the pigment permeation layer, and at least one second solvent absorption layer which is laminated on the first solvent absorption layer, and
the second solvent absorption layer is formed to be removable from the first solvent absorption layer.

8. The manufacturing method of a light transmission filter according to claim 7, further comprising:
an air gap removing step of removing at least a part of an air gap of the first solvent absorption layer.

9. The manufacturing method of a light transmission filter according to claim 1,
wherein in the ink applying step, a plurality of types of pigment inks for a light transmission filter are applied to the ink receiving layer.

10. The manufacturing method of a light transmission filter according to claim 1,
wherein in the ink applying step, a color image is formed by applying three types of pigment inks for a light transmission filter of red, green, and blue to different positions of the ink receiving layer.

11. The manufacturing method of a light transmission filter according to claim 10,
wherein in the ink applying step, a black pigment ink is applied to a portion in which the color image is not formed, prior to the application of the three types of pigment inks for a light transmission filter.

12. The manufacturing method of a light transmission filter according to claim 11,
wherein in the ink applying step, a grid black matrix is formed by the black pigment ink, and the three types of pigment inks for a light transmission filter are applied to each of a plurality of frames formed by the black matrix one color by one color.

13. The manufacturing method of a light transmission filter according to claim 1,
wherein the ink receiving layer is supported on a substrate.

14. A manufacturing apparatus of a light transmission filter, comprising:
an ink applying unit applying a pigment ink for a light transmission filter to an ink receiving layer formed by mutually laminating a pigment permeation layer which is capable of allowing a pigment particle and a solvent contained in the pigment ink to permeate, and a solvent absorption layer having an air gap structure which is capable of inhibiting permeation of the pigment particle and of absorbing the solvent, from the pigment permeation layer side; and
a solvent absorption layer removing unit removing at least a part of the solvent absorption layer containing a solvent component of the pigment ink from the ink receiving layer.

15. A transfer material for a light transmission filter, comprising:
a solvent absorption layer which is capable of inhibiting permeation of a pigment particle contained in a pigment ink for a light transmission filter and of allowing a solvent to permeate in the pigment ink; and
a pigment permeation layer which is laminated on the solvent absorption layer, and is capable of allowing the pigment particle and the solvent to permeate,
wherein the pigment permeation layer of the transfer material is configured of a material which is formed into a molten film by a pressurizing and heating treatment, and
the solvent absorption layer of the transfer material is configured of a material which maintains an air gap structure even in a case in which the pressurizing and heating treatment is performed, and is configured to be removable from the pigment permeation layer.

16. The transfer material for a light transmission filter according to claim 15,
wherein the solvent absorption layer is formed of a first solvent absorption layer which is in contact with the pigment permeation layer, and at least one second solvent absorption layer which is laminated on the first solvent absorption layer, and
the second solvent absorption layer is formed to be removable from the first solvent absorption layer.

17. A light transmission filter, comprising:
a pigment permeation layer which is capable of allowing a pigment particle and a solvent contained in a pigment ink for a light transmission filter to permeate; and
the pigment particle which is retained in an air gap formed in the pigment permeation layer.
